(19) United States
(12) Patent Application Publication
(10) Pub. No.: US 2006/0063137 A1
(43) Pub. Date: Mar. 23, 2006

(54) Wheeled vehicles and control systems and methods therefor

(76) Inventor: Alan R. Robbins, Winchester, MA (US)

Correspondence Address: THOMAS P O'CONNELL, 135 CAMBRIDGE STREET SUITE 10, BURLINGTON, MA, 01803, US

(21) Appl. No.: 11/215,387

(22) Filed: Aug. 30, 2005

Related U.S. Application Data
(63) Continuation-in-part of application No. 10/783,697, filed on Feb. 21, 2004.

(51) Int. Cl. G09B 19/16

(52) U.S. Cl. 434/61

(57) ABSTRACT

Balance and steering systems and methods. In one aspect, a balance practice device with an inverted pendulum balanced with a steering arrangement. In another aspect, first and second two-wheeled vehicles coupled in parallel for simultaneous banking by a motorized banking arrangement, a laterally moveable weight, or a mechanism for steering the steering arrangements of the first and second two-wheeled vehicles. Still other aspects of the invention have a laterally moveable two-wheeled vehicle and a tiltable display scene for simulating vehicular motion. Alternatively, a two-wheeled vehicle can be retained relative to a pivotally supported arm. Still further, a vehicle can have front and rear wheeled trucks each with a cambered caster wheel for inducing a difference between the angle of attack of the trucks and a longitudinal orientation of the vehicle.

### FIELD OF THE INVENTION

The present invention relates generally to land vehicles. Stated more particularly, this patent discloses and protects plural embodiments of wheeled vehicles and control systems and methods for those vehicles, both as embodied in reality and in simulations thereof.

### SUMMARY OF THE INVENTION

A basic object of certain embodiments of the present invention is to provide simulated two-wheeled vehicles and control system and methods therefor that operate in truly accurate simulation of two-wheeled vehicular function.

A fundamental object of particular objects of the invention is to provide actual two-wheeled vehicles that can be remote controlled in realistic representation of actual two-wheeled vehicle riding and control.

An essential object of still other embodiments of the present invention is to provide wheeled transportation vehicles for providing an occupant with stability and safety during wheeled vehicular operation.

Another object of certain embodiments of the invention is to provide wheeled vehicles capable of imitating lateral traction losses.

These and further objects and advantages of the invention will become obvious not only to one who reviews the present specification and drawings but also to one who has an opportunity to make use of an embodiment of the present invention. However, it will be appreciated that, although the accomplishment of each of the foregoing objects in a single embodiment of the invention may be possible and indeed preferred, not all embodiments will seek or need to accomplish each and every potential object and advantage. Nonetheless, all such embodiments should be considered within the scope of the present invention.

One will appreciate, however, that the present discussion broadly outlines certain more important goals and features of the invention to enable a better understanding of the detailed description that follows and to instill a better appreciation of the inventor's contribution to the art. Before an embodiment of the invention is explained in detail, it must be made clear that the following details of construction, descriptions of geometry, and illustrations of inventive concepts are mere examples of the many possible manifestations of the invention.

### BRIEF DESCRIPTION OF THE DRAWINGS

In the accompanying drawing figures:

FIG. 1 is a spatial view of a two-wheeled vehicle, namely a bicycle, banked away from vertical by an angle θ_{z};

FIG. 1B is a schematic view depicting a shift in center of gravity relative to the two-wheeled vehicle;

FIG. 1C is a schematic view depicting forces deriving from a torquing of the steering arrangement;

FIG. 1D is a further schematic view depicting forces deriving from a torquing of the steering arrangement;

FIG. 2 is a view in rear elevation of a control system for a visually simulated two-wheeled vehicle according to the present invention;

FIG. 3 is a view in side elevation of a remote control system for a physical simulation of a two-wheeled vehicle pursuant to the present invention;

FIG. 4 is a view in side elevation of an alternative embodiment of a remote control system for a physical simulation of a two-wheeled vehicle according to the present invention;

FIG. 5 is a view in side elevation of another embodiment of a remote control system for a physical simulation of a two-wheeled vehicle pursuant to the present invention;

FIG. 6A is a view in side elevation of a remote riding control system for an actual two-wheeled vehicle according to the present invention;

FIG. 6B is a view in front elevation of an alternative remote riding control unit;

FIG. 7 is a view in rear elevation of a fitness-oriented control system for a visually simulated two-wheeled vehicle according to the present invention;

FIG. 8A is a perspective view of a flat tracker two-wheeled vehicle motion simulation platform according to the present invention;

FIG. 8B is a perspective view of the flat tracker two-wheeled vehicle motion simulation platform of FIG. 8A in simulation of flat tracker two-wheeled vehicular motion;

FIG. 8C is a schematic top plan view of a quick response motion arrangement pursuant to the present invention;

FIG. 8D is a schematic top plan view depicting the force relationships of a spinning rear wheel of a two-wheeled vehicle;

FIG. 9 is a perspective view of a flat tracker two-wheeled vehicle motion simulation platform configured for travel on rails;

FIG. 10 is a perspective view of a flat tracker two-wheeled vehicle motion simulation platform configured for travel over land;

FIG. 11 is a perspective view of a flat tracker two-wheeled vehicle motion simulation platform configured for travel on water;

FIG. 12 is a schematic top plan view of a gyroscopically stabilized two-wheeled vehicle pursuant to the present invention;

FIG. 13 is a view in side elevation of the gyroscopically stabilized two-wheeled vehicle of FIG. 12;

FIG. 14 is a view in front elevation of the gyroscopically stabilized two-wheeled vehicle of FIG. 12;

FIG. 15 is a view in side elevation of an alternative gyroscopically stabilized two-wheeled vehicle;

FIG. 16 is a partially sectioned perspective view of a wheeled truck pursuant to another embodiment of the invention;

FIG. 17 is a perspective view of a kart taking advantage of a plurality of wheeled trucks under the present invention;

FIG. 18 is a top plan view of a simplified version of the kart of FIG. 17;

FIG. 19A is a perspective view of a cycle incorporating two wheeled trucks as disclosed herein;

FIG. 19B is a perspective view of a forward portion of another alternative cycle incorporating wheeled trucks;

FIG. 20 is a perspective view of a wheeled foot truck pursuant to the instant invention;

FIG. 21 is a perspective view of an inverted pendulum manual balancing practice arrangement as disclosed herein;

FIG. 22 is a view in side elevation of a vehicle incorporating a caster steering arrangement under the instant invention;

FIG. 23 is a view in front elevation of a dual cycle arrangement as taught herein;

FIG. 24 is a top plan view of the dual cycle arrangement of FIG. 23; and

FIG. 25A is a view in front elevation of an alternative dual cycle arrangement under the present invention;

FIG. 25B is a view in front elevation of still another alternative dual cycle arrangement under the present invention;

FIG. 25C is a view in front elevation of a platform for sensing a change in a user's center of gravity;

FIG. 26 is a circuit diagram for the servomotor of the embodiment of FIGS. 23 and 24;

FIG. 27 is a view in rear elevation of a further simulation arrangement as taught herein;

FIG. 28 is a perspective view of a three-dimensional motion simulation arrangement;

FIG. 29 is a perspective view of a three-dimensional motion arrangement for a front wheel of the three-dimensional motion simulation arrangement of FIG. 28; and

FIG. 30 is a perspective view of a three-dimensional motion arrangement for a rear wheel of the three-dimensional motion simulation arrangement of FIG. 28.

### DETAILED DESCRIPTION OF PREFERRED EMBODIMENTS

As with many inventions, the present invention for two-wheeled vehicles and control systems and methods therefor can assume a wide variety of embodiments. However, to assist those reviewing the present disclosure in understanding and, in appropriate circumstances, practicing the present invention, certain exemplary embodiments of the invention are described below and shown in the accompanying drawing figures.

Theoretical Method of Operation.

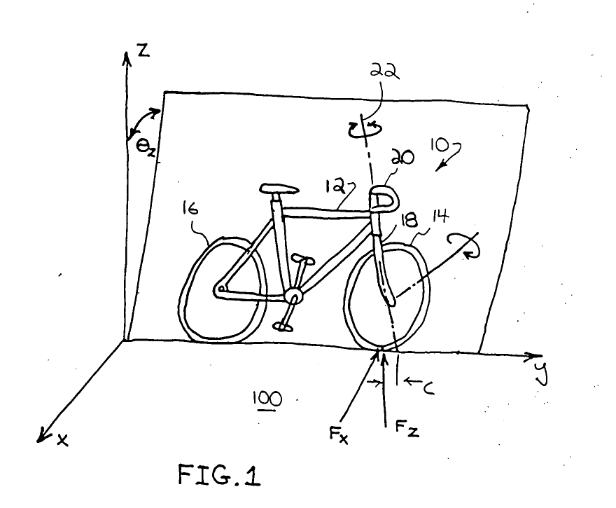

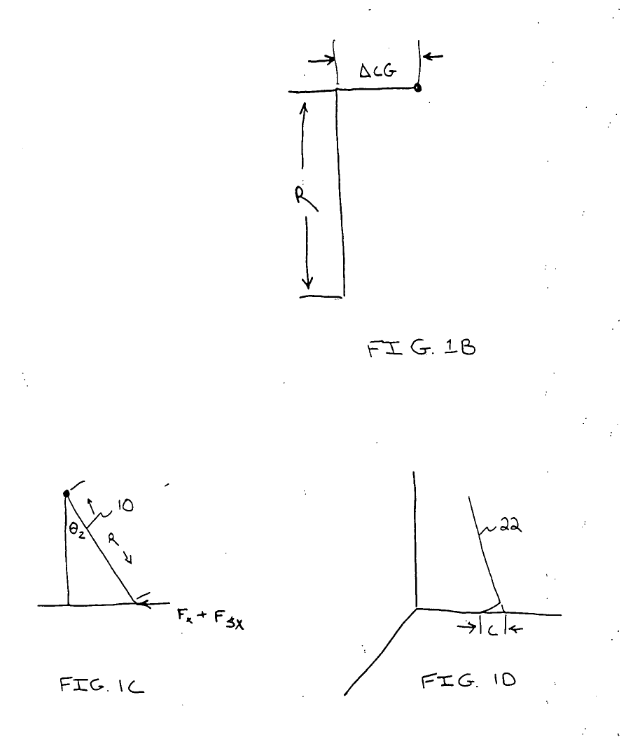

To gain a basic understanding of the theoretical method of operation that can be incorporated into each of the embodiments disclosed herein, one can give reference first to FIG. 1. There, an exemplary two-wheeled vehicle, in this case a typical bicycle, is indicated generally at 10. The two-wheeled vehicle 10 is disposed within a spatial framework defined by x, y, and z axes. The two-wheeled vehicle 10 can be considered to have a path of travel over a support surface 100 along the y axis with the x axis being perpendicular to the path of travel and the z axis defining true vertical. With the two-wheeled vehicle 10 traveling along they axis, they axis can be considered to be a roll axis about which the two-wheeled vehicle 10 can be considered to bank.

The two-wheeled vehicle 10 is founded on a frame 12. The orientation of the two-wheeled vehicle 10 with respect to vertical can be considered to be defined by the orientation of the frame 12. A rear wheel 16 is rotatably retained relative to the frame 12. A front wheel 14 is rotatably retained relative to the frame 12 and in tandem with the rear wheel 16 by a steering fork 18. The orientation of the steering fork 18 and the front wheel 14 relative to the frame 12 can be controlled by a steering arrangement 20 to cause a pivoting about a steering axis 22.

The steering axis 22 projects rearwardly relative to true vertical to yield a positive caster distance C defined by the distance between the lead point where the steering axis 22 intersects the support surface 100 and the point of contact of the front wheel 14 relative to the support surface 100. The positive caster distance C gives the two-wheeled vehicle 10 directional stability since the load of the two-wheeled vehicle 10 and its cargo will be projected in front of the center or point of the tire contact area whereby the front wheel 14 can be considered to be biased to a straight-ahead orientation by a caster torque T_{c}. As such, the positive caster distance C where the point of load being ahead of the point of contact causes the two-wheeled vehicle 10 to resist being steered away from a straight-ahead disposition.

The orientation of the two-wheeled vehicle 10 with respect to vertical can be considered to be defined by the orientation of the frame 12. In the example of FIG. 1, the two-wheeled vehicle 10 is tilted away from vertical through a bank angle θ_{z} as it would be while undertaking a left turn. During such a banking of the two-wheeled vehicle 10, the front wheel 14 and the support surface 100 will exert equal and opposite forces relative to one another. A downward component of the force exerted by the front wheel 14 of the two-wheeled vehicle 10 is opposed by a vertical force component F_{z} exerted by the support surface 100, and a lateral component the force exerted by the front wheel 14 of the two-wheeled vehicle 10 during the turn is opposed by a lateral force component Fₓ exerted by the support surface 100 to the left.

Under the Theoretical Method of Operation disclosed herein, the vertical force component F_{z} produces a counter-clockwise torque, which can be termed a vertical-force induced torque T_{z}, on the steering arrangement 20 when the two-wheeled vehicle 10 is banked to the left. The opposite would be true where the two-wheeled vehicle 10 is banked to the right. In any case, the vertical-force induced torque T_{z} will tend to cause the steering arrangement 20 to turn deeper into the turn being undertaken by the two-wheeled vehicle 10. That vertical-force induced torque T_{z} can be approximated by Equation 1 below.
T_{z}=(F_{z})(C)(sin θ_{z}) (Equation 1)

Likewise, the lateral force component Vₓ will produce a torque on the steering arrangement 20, which can be termed a lateral-force induced torque Tₓ. The lateral-force induced torque Tₓ will tend to steer the two-wheeled vehicle 10 out of the turn. Therefore, where the two-wheeled vehicle 10 is disposed in a left turn as depicted in FIG. 1, the lateral-force induced torque Tₓ will be in the clockwise direction. If the two-wheeled vehicle 10 were oppositely banked in a right turn, the vertical-force induced torque T_{z} would operate in a clockwise direction while the lateral-force induced torque Tₓ would operate in a counter-clockwise direction. The lateral-force induced torque Tₓ can be approximated by Equation 2 below.
Tₓ=(Fx)(C)(cos θ_{z}) (Equation 2)

In either case, the vertical-force induced torque T_{z} and the lateral-force induced torque Tₓ will operate in opposition. With the steering axis 22 in the same plane as the frame 12, no net torque about the roll axis y will result therefrom. Accordingly, the vertical-force induced torque T_{z} and the lateral-force induced torque Tₓ will tend to reach an equilibrium where T_{z} equals Tₓ. With T_{z} equaling Tₓ, the two-wheeled vehicle 10 itself will tend toward an equilibrium state where the two-wheeled vehicle 10 will tend neither toward a deeper bank angle θ_{z} nor a shallower bank angle θ_{z}. Each embodiment of the invention disclosed herein can be caused to operate or can be treated as being operable under this Theoretical Method of Operation.

The equilibrium can be disturbed in two basic ways: by a rider's imparting a steering torque on the steering arrangement 20 and/or by producing a shifting of the center of gravity of the overall mass of the two-wheeled vehicle 10 and the rider as by leaning. FIG. 1B shows schematically a shift in center of gravity relative to the two-wheeled vehicle. The roll acceleration deriving from the shift in center of gravity can be determined by Equation 3 below.
Roll Acceleration=(ΔCG/R²)(G/cos θ_{z}) (Equation 3)

Where,

ΔCG is the horizontal change in the location of the center of gravity;

R is the radius of gyration; and

G is gravity.

The roll acceleration deriving from a steering torque Tₛ applied to the steering arrangement 20 can be calculated employing Equation 4 below.
Roll Acceleration=(((TₛG)/(C Cos θ_{z}))( Cos θ_{z}))/M)/R (Equation 4)

Where,

Tₛ is the steering torque;

G is gravity;

C is the caster distance;

M is the total mass; and

R is the radius of gyration.

Control of Visually Simulated Two-Wheeled Vehicle

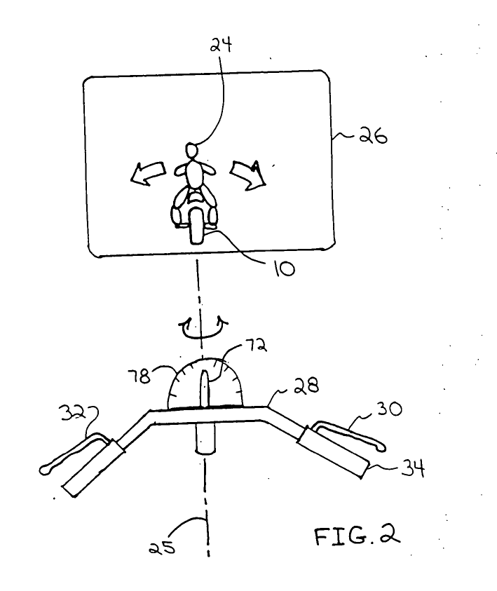

A first example of the many possible applications of the aforedescribed Theoretical Method of Operation is depicted in FIG. 2. There, a visually simulated two-wheeled vehicle 10, in this example comprising a motorcycle, is displayed on a display screen 26 retaining a simulated rider 24. A steering arrangement 28, in this case handlebars, is pivotable about a steering axis 25 to impart a steering control over the simulated two-wheeled vehicle 10 and the simulated rider 24 employing a control system. The steering arrangement 28 can be retained relative to any appropriate structure (not shown in FIG. 2). By operation of the steering arrangement 28 and, preferably, based on a control system founded on the Theoretical Method of Operation disclosed herein, a user can control the simulated two-wheeled vehicle 10 in a manner that simulates the reality of two-wheeled vehicular motion most accurately. An indicator wand 72, which can be an actual wand or a visual representation thereof, can be operably associated with the steering arrangement 28, the display screen 26, or otherwise disposed to be viewed by the user for providing an indication of the bank angle θ_{z} of the two-wheeled vehicle 10 to better enable the person's control thereover. A graduated scale 78 can act as a backdrop for the indicator wand 72.

A user can manipulate the steering arrangement 28 by a pivoting about the steering axis 25 based on the visual feedback provided by the display of the simulated two-wheeled vehicle 10 and/or by the indicator wand 72 to attempt to steer, balance, and maintain the overall stability of the simulated two-wheeled vehicle 10 during simulated vehicular movement. Control over the simulated two-wheeled vehicle 10 can be enhanced in certain embodiments by an accelerator 34, a braking lever 30, and a clutch lever 32 with the effect of each control means being realistically reflected in the operation of the simulated two-wheeled vehicle 10.

Under such an arrangement, a user can gain a realistic perception of the banking, turning, and other control characteristics and requirements of a two-wheeled vehicle without or prior to actually undertaking such activity. To do so, the user will impart a steering torque Tₛ on the steering arrangement 28 to disturb the equilibrium that would otherwise tend to exist between the vertical-force induced torque T_{z} and the lateral-force induced torque Tₓ to initiate an adjustment of the orientation of the front wheel 14 and the orientation of the two-wheeled vehicle 10 in general. With this, the two-wheeled vehicle 10 can be controlled in a stable manner by being selectively induced into a deeper bank angle θ_{z} or a shallower bank angle θ_{z} as may be necessary to effectuate the desired steering control.

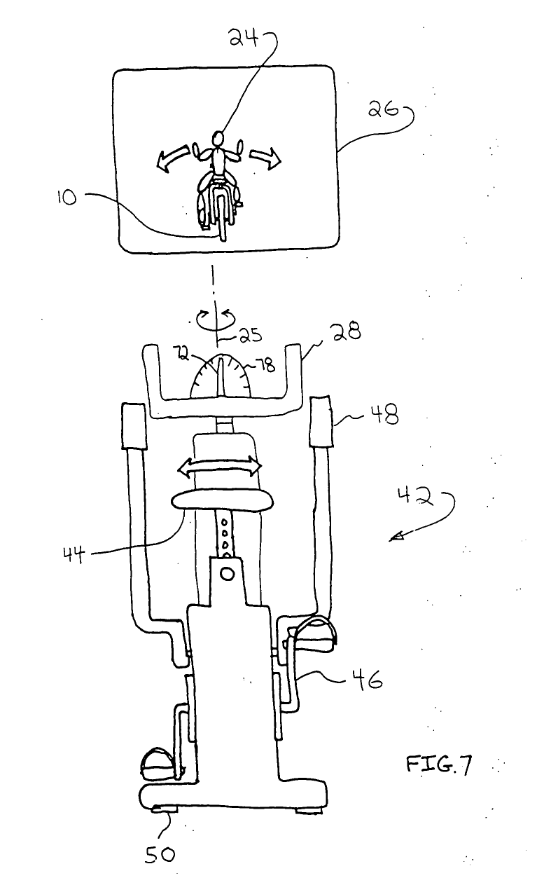

Another visually simulated two-wheeled vehicle 10 is depicted in FIG. 7 where the simulated two-wheeled vehicle 10 is again depicted on a display screen 26 retaining a simulated rider 24. A steering arrangement 28 can again be pivoted about a steering axis 25 to effect a control of the steering, balance, and other handling characteristics of the simulated two-wheeled vehicle 10. In this case, however, the steering arrangement 28 is retained relative to a seating arrangement 42 that has a seat 44 on which a rider can sit. An indicator wand 72, which can be an actual wand or a visual representation thereof, can be operably associated with the steering arrangement 28, the display screen 26, or otherwise disposed to be viewed by the user for providing an indication of the bank angle θ_{z} of the two-wheeled vehicle 10 to better enable the person's control thereover. Again, a graduated scale 78 can act as a backdrop for the indicator wand 72. The seating arrangement 42 can incorporate load cells 50 or any other means for sensing a weight distribution of the rider.

Under this arrangement, the rider can impart a controlling force that can be sensed by the sensing means by leaning or otherwise shifting his or her weight relative to the seating arrangement 42. More particularly, the sensing means can perceive a change in the rider's center of gravity and, based on that change in center of gravity, can determine what the effect would be on an actual bicycle, which can be assumed to follow the Theoretical Method of Operation disclosed herein, and then depict that effect relative to the simulated two-wheeled vehicle 10 on the display screen 26. With this, a rider can lean and otherwise manipulate his or her center of gravity to supplement or replace the control that could be imparted by use of the steering arrangement 28. Indeed, as one may infer from the depiction of the simulated rider 24 of FIG. 7, the actual rider could control the simulated two-wheeled vehicle 10 only by the aforementioned leaning or other weight redistribution to simulate riding a two-wheeled cycle with no hands. In certain applications, the seating arrangement 42 could pursue an exercise format, such as with the incorporation of cycle pedals 46 and, additionally or alternatively, arm levers 48.

Under such a construction, a mathematical model of the performance can be determined as follows. The radius of gyration can be assumed to be 4 feet about the support surface. The weight of the simulated two-wheeled vehicle 10 and rider can be assumed to be 200 lbs total. With such an arrangement, the angular acceleration and the lateral acceleration can be respectively determined by Equations 5 and 6 below.

$$\begin{matrix}\ddot{θ} = \frac{T}{200 lbs} \cdot \frac{1}{{( 4 ft )}^{2}} \cdot 32 {\text{ft/s}}^{2} \cdot \frac{1}{cos θ} & ( Equation 5 ) \\ Lateral Acceleration = 32 {\text{ft/s}}^{2} \cdot ( tan θ ) & ( Equation 6 )\end{matrix}$$

Where T is the torque deriving from the rider's lateral leaning based on the readings of the load cells 50.

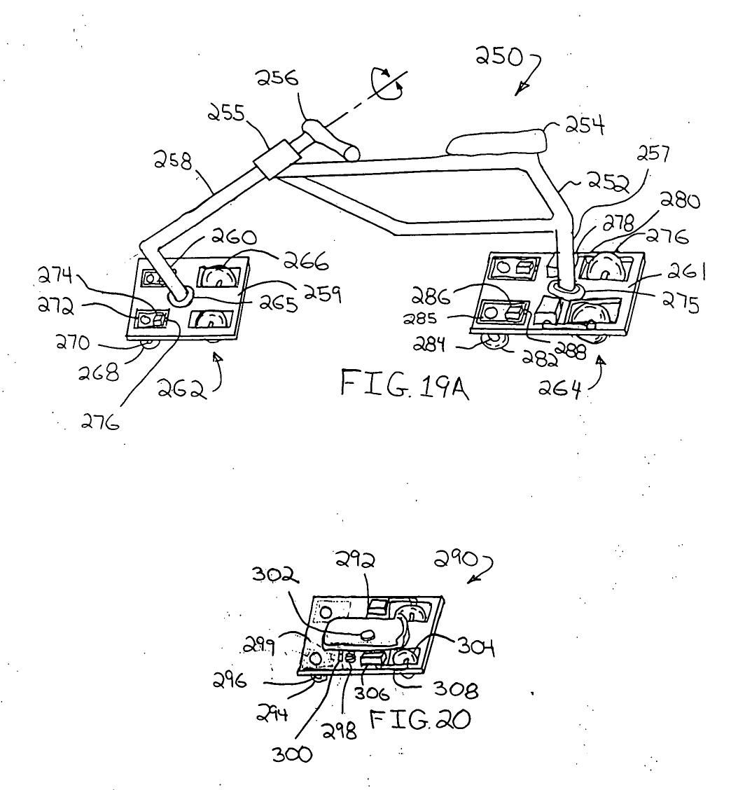

A balance practice device is shown generally at 310 in FIG. 21. The balance practice device 310, which is purely mechanical, enables a user to attempt to balance an inverted pendulum 342 by operation of a steering arrangement 312. With this, a user can not only enjoy the challenges of attempting to balance the pendulum but can also learn many of the skills required for stable operation of a two-wheeled vehicle in an entirely safe environment.

The steering arrangement 312 can have a steered rod 314. A biasing rod 316 can project radially from the steered rod 314. A counter-clockwise tension spring 320 can be coupled to the biasing rod 316 to provide proportional resistance to a counter-clockwise steering of the steering arrangement 312, and a clockwise tension spring 320 can be coupled to the biasing rod 316 to provide proportional resistance to a clockwise steering of the steering arrangement 312. The tension springs 318 and 320 can have equal spring constants. With this, the biasing rod 316 and thus the steering arrangement 312 will be biased to a neutral orientation and will experience a proportionally increasing resistance to steering. The steering torque required to overcome a given roll acceleration of the pendulum 342 will be proportional thereto.

An actuating, rod 322, which can also comprise the biasing rod 316 or can be a separate member as in the present example, can have a first end of an elongate flexible member 334 coupled thereto. The elongate flexible member 334 can be coupled to a first end of a first lateral spring 338 and can, but need not, overly a direction changing member, such as a pulley 336. A second end of the first lateral spring 338 can be coupled to a body portion of the pendulum 342 spaced from a pivot axis 344 of the pendulum 342. An adjustment means, such as a threaded turnbuckle 335, can be interposed between the first lateral spring 338 and the flexible member 334 to enable a calibration of the balance practice device 310 to establish a neutral equilibrium of the pendulum 342. A second lateral spring 340 can have a first, fixed end and a second end coupled to the body portion of the pendulum 342 in alignment with the second end of the first lateral spring 338. The first and second lateral springs 338 and 340 can have equal spring constants.

The spring constants of the first and second lateral springs 338 and 340, the spring constants of the tension springs 318 and 320, and the lengths of the biasing and actuating rods 316 and 320 can be calibrated to ensure that the forces exhibited by the flexible member 334 on the actuation rod 322 and, therefore, the steering arrangement 312 will be substantially negligible in relation to the forces exhibited by the tension springs 318 and 320. One or more weights 346 can be selectively coupled to the pendulum 342 for affecting the balancing requirements thereof.

Under this arrangement, a user can turn the steering arrangement 312 to control the flexible member 334 and the forces applied to the pendulum 342 to attempt to control, maneuver, and balance the pendulum 342. A pivoting of the steering arrangement 315 counter-clockwise will tend to draw the pendulum 342 to the right while a pivoting of the steering arrangement 315 clockwise will tend to draw the pendulum 342 to the right. Although it is not shown, a means can be provided for enabling a user to attempt to maneuver the pendulum 342 around obstacles or through a scene. One using such an embodiment of the invention can thus gain an ability to balance an object against gravity in a safe and enjoyable manner.

An alternative embodiment of the balance practice device 310 can enable a counterbalancing of the pendulum 342 by a means for sensing a weight shift by a user. For example, a pivotable platform or other weight shift sensing member (not shown) can be provided for pulling on the flexible member 334 in response to a pivoting of the platform. With this, a user could practice no hands maneuvering of a vehicle.

Remote Control of Physical Simulation of Two-Wheeled Vehicle

The invention could further be employed in relation to the remote control of a physical simulation of a two-wheeled vehicle 10 as is depicted, by way of example, in FIG. 3. There, a person 36, whether an adult or a child, controls a two-wheeled vehicle 10, in this case a bicycle, by a pivoting of a remote steering arrangement 28, which can be pivotable about a steering axis 25. The remote steering arrangement 28 could pivot about the steering axis 25 by any appropriate means including by having a portion thereof retained relative to the person 36, by having a portion thereof retained relative to a mobile support arrangement (not shown in FIG. 3), by incorporation of a means for sensing an orientation of the remote steering arrangement 28, or by any other appropriate means. Again, an indicator wand 72, which can be an actual wand or a visual representation thereof, can be operably associated with the steering arrangement 28 or otherwise disposed to be viewed by the user for providing an indication of the bank angle θ_{z} of the two-wheeled vehicle 10 to better enable the person's control thereover. A graduated scale 78 can act as a backdrop for the indicator wand 72.

The two-wheeled vehicle 10 in the embodiment of FIG. 3 can have a frame 12 retaining front and rear wheels 14 and 16. The orientation of the front wheel 14 can be controlled by a steering arrangement 20 that pivots about a steering axis 22. A propulsion system 38 can provide propulsive force to the two-wheeled vehicle 10, such as by inducing a rotation of the rear wheel 16. A steering controller 40 can control the orientation of the steering arrangement 20 and the front wheel 14 in response to a control signal provided by the remote steering arrangement 28. A banking arrangement 35, which can take any appropriate form, can adjust the bank angle θ_{z} of the two-wheeled vehicle 10 to simulate the banking responses that would be demonstrated by an actual two-wheeled vehicle 10, which can be assumed to operate under the Theoretical Method of Operation disclosed herein. In this example, the banking arrangement 35 comprises opposed wheeled hydraulic or other extensible and retractable members. However, it will be clear that innumerable banking arrangements 35 would readily occur to one skilled in the art after reading this disclosure.

Under this arrangement, a person 36 can achieve realistic control over the physical simulation of the two-wheeled vehicle 10 by operation of the remote steering arrangement 28. For example, with the propulsion system 38 propelling the two-wheeled vehicle 10 forward at some vehicle speed, the person 36 can induce a pivoting of the steering arrangement 20 of the two-wheeled vehicle 10 by a pivoting of the remote steering arrangement 28 thereby to steer and balance the two-wheeled vehicle 10, which again can be assumed to operate under the Theoretical Method of Operation described herein. The control over the banking and other characteristics of the two-wheeled vehicle 10 can be carried out assuming the two-wheeled vehicle 10 to be traveling at its actual vehicular speed or based on some upward or, more likely, downward scaling of the vehicular speed and the performance characteristics attendant thereto. With this, the user can watch and/or follow behind the two-wheeled vehicle 10 to experience, demonstrate, and, if necessary, learn the balancing and control requirements for maintaining an actual two-wheeled vehicle in a stable manner.

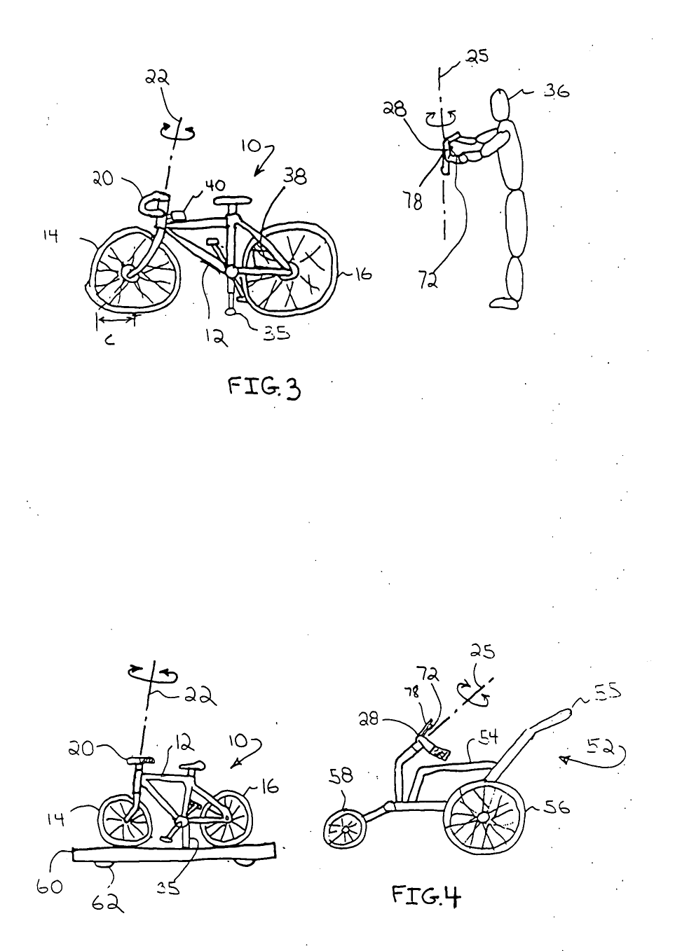

Another system for enabling the remote control of a physical simulation of a two-wheeled vehicle 10 is depicted in FIG. 4. There, the physical simulation of the two-wheeled vehicle 10, again taking the form of a bicycle, is mounted on a mobile platform 60 that incorporates a means for traveling over a support surface, which can be a solid surface, a water surface, or any other support surface. In this example, the means for traveling over a support surface comprises a plurality of wheels 62, which can be rotatable and pivotable to enable a maneuvering of the mobile platform 60 and, therefore, the two-wheeled vehicle 10 over substantially any path of travel. The steering arrangement 20 and the front wheel 14 can again be pivoted about a steering axis 22 under the remote control of a remote steering arrangement 28 that is pivotable about a steering axis 25. The bank angle θ_{z} of the two-wheeled vehicle 10 can be adjusted to simulate the banking responses that would be demonstrated by an actual two-wheeled vehicle 10 by a banking arrangement 35, which again can take any appropriate form. In this example, the banking arrangement 35 comprises a pivotable rod. The operation of the two-wheeled vehicle 10 can again be controlled based on the Theoretical Method of Operation disclosed herein. An indicator wand 72, which can be an actual wand or a visual representation thereof, can be operably associated with the steering arrangement 28 or otherwise disposed to be viewed by the user for providing an indication of the bank θ_{z} of the two-wheeled vehicle 10 to better enable the person's control thereover. A graduated scale 78 can act as a backdrop for the indicator wand 72.

In the embodiment of FIG. 4, the steering arrangement 28 is pivotally retained relative to a vehicle frame 54 of a remote control vehicle 52. The remote control vehicle 52 in this embodiment takes the form of a wheeled vehicle similar to a typical jogging stroller that has relatively large rear wheels 56 and a relatively smaller front wheel 58 rotatably retained relative to the vehicle frame 54. The vehicle frame 54 either includes or retains a handle 55. Under such an arrangement, a person seeking to control the two-wheeled vehicle 10, such as a child seeking to learn how to control and ride an actual bicycle or one merely wanting to enjoy attempting to control the two-wheeled vehicle 10, can sit in the remote control vehicle 52 most likely while being pushed behind the moving two-wheeled vehicle 10 and mobile platform 60 by another person. In certain embodiments, the steering arrangement 28 can incorporate a means for exhibiting a torque during operation of the two-wheeled vehicle 10 that is simulative of the torque that would be exhibited by an actual two-wheeled vehicle under the represented vehicular speed and other conditions. That torque and the performance characteristics of the two-wheeled vehicle 10 can again be governed by the Theoretical Method of Operation described herein.

A fuller understanding may be had by reference to a mathematical example of the control of a simulated two-wheeled vehicle 10. One can assume that the lean angle is zero when the two-wheeled vehicle 10 is in a vertical disposition and positive when leaned to the right. One can also assume that the angle of the steering arrangement 20 or handlebars 20 is zero when in a neutral position and positive when turned to the right. An exemplary two-wheeled vehicle 10 can be assumed to be traveling at 8 ft/s and to have a radius of gyration of 3 feet and a wheel base of 32 inches. The rider can be assumed to weigh 50 lbs, and a caster of 2 inches can be employed. One can further assume that the simulated tire demonstrates a slip angle of 0.1 radians at maximum lateral force. The system can impart a torque to the handlebars 20 when they are turned to produce a torque feedback. With such an arrangement, the feedback torque, the angular acceleration, and the lateral acceleration can be respectively determined by Equations 7, 8, and 9 below.

$$\begin{matrix}T = \frac{2}{12 \text{in/ft}} \cdot 25 lb \cdot \frac{[ ψ - ( \frac{32 in}{12 \text{in/ft}} \cdot 32 f / {s}^{2} {( 8 \text{ft/s} )}^{2} ]}{0.1 radian} & ( Equation 7 ) \\ \ddot{θ} = - \frac{12 \text{in/ft}}{2 in} [ \frac{T}{25 lb} ] \frac{1}{3 ft} \cdot 32 {\text{ft/s}}^{2} & ( Equation 8 ) \\ Lateral Acceleration = 32 {\text{ft/s}}^{2} \cdot [ tan θ + \frac{12 \text{in/ft}}{2 in} \cdot \frac{T}{25 lb} ] & ( Equation 9 )\end{matrix}$$

Where ψ is the handlebar angle.

Equation 9 can be expressed generically as in Equation 9A below.

$$Lateral Acceleration = G [ tan θ + \frac{T}{( \text{1/2} M ) ( C )} ] \qquad ( Equation 9 A )$$

Where M is the mass of the vehicle and rider and C is the caster distance.

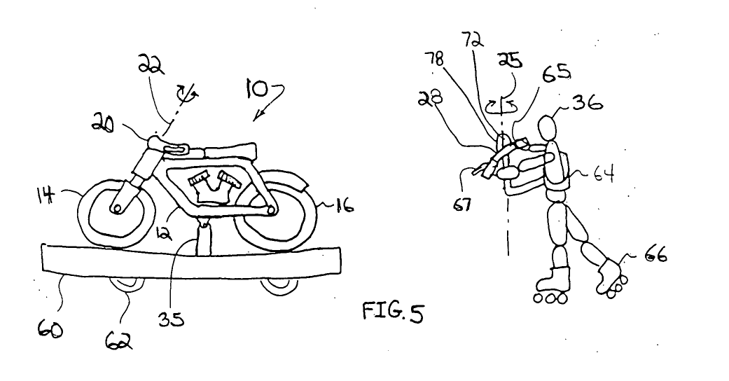

FIG. 5 depicts still another system for enabling the remote control of a physical simulation of a two-wheeled vehicle 10. In the embodiment of FIG. 5, the remote steering arrangement 28 is retained directly by the person 36 by a harness arrangement 64. Also, the person 36 in this example is outfitted with wheeled skates 66 for better enabling him or her to follow the two-wheeled vehicle during movement thereof. The two-wheeled vehicle 10 in this physical simulation comprises a simulation of a motorcycle. The two-wheeled vehicle 10 is again disposed on a mobile platform 60 that can be propelled by steerable wheels 62. The bank angle θ_{z} of the two-wheeled vehicle 10 can be adjusted to simulate the banking responses that would be demonstrated by an actual two-wheeled vehicle 10 by a banking arrangement 35. The steering arrangement 20 of the two-wheeled vehicle 10 can be caused to pivot about the pivot axis 22 by the remote control of the remote steering arrangement 28. An indicator wand 72, which again can be an actual wand or a visual representation thereof, can be operably associated with the steering arrangement 28 or otherwise disposed to be viewed by the user for providing an indication of the bank angle θ_{z} of the two-wheeled vehicle 10 to better enable the person's control thereover. A graduated scale 78 can act as a backdrop for the indicator wand 72.

In certain embodiments, the remote steering arrangement 28 can provide the person 36 with a sensation of the actual torque characteristics that would be experienced during control of an actual two-wheeled vehicle. The physical simulation of the two-wheeled vehicle 10 can in particular embodiments comprise a miniature simulation of an actual two-wheeled vehicle and accordingly can exhibit scaled velocity and, possibly, other performance characteristics. Under this arrangement, a person 36 can travel, such as by skating, behind the two-wheeled vehicle 10 while controlling the same by use of the steering arrangement 28. The steering arrangement 28 can further include an accelerator 65 and a brake lever 67 for enabling the person 36 to control the relative velocity of the two-wheeled vehicle.

With this, one person 36 or multiple persons 36 could each control a two-wheeled vehicle 10 in any appropriate manner including, by way of example, by manipulating the two-wheeled vehicle 10 through a designated race, obstacle, or similar course. The two-wheeled vehicle 10 could be propelled by the mobile platform 60 at a scaled speed, such as in a 6:1 scaling. To facilitate the realistic simulation of two-wheeled vehicle operation, the control system could incorporate what could essentially be described as a penalty function to establish adverse effects deriving from a person's controlling the simulated two-wheeled vehicle 10 beyond what would be the performance limits of the actual vehicle being simulated. For example, where a rider imparts control signals to the two-wheeled vehicle 10 that would cause an actual vehicle to skid around a turn or to have its front or rear wheel 14 or 16 otherwise lose traction, the control system could induce the controlled two-wheeled vehicle 10 to simulate a loss in traction, to slow, or otherwise to establish a loss in performance.

A mathematical model of the foregoing embodiment is provided below. In the example, the function of the handlebars 20 is slightly simplified to provide a torque feedback that increases proportionally to the angle to which the handlebars 20 are turned. The simulated system can assume a radius of gyration of 4 feet, a trail or caster of 3 inches, and a weight of the rider and the two-wheeled vehicle of 500 lbs.

With such an arrangement, the feedback torque, the angular acceleration, and the lateral acceleration can be respectively determined by Equations 10, 11, and 12 below.

$$\begin{matrix}T = \frac{3 in}{12 \text{in/ft}} \cdot 250 lb \cdot \frac{ψ}{0.1 rad} & ( Equation 10 ) \\ \ddot{θ} = - \frac{T}{250} \cdot \frac{1}{4 ft} \cdot 32 {\text{ft/s}}^{2} \cdot \frac{12 \text{in/ft}}{3 in} & ( Equation 11 ) \\ Lateral Acceleration = 32 {\text{ft/s}}^{2} [ tan θ + \frac{12 \text{in/ft}}{3 in} \cdot \frac{T}{250 lb} ] & ( Equation 12 )\end{matrix}$$

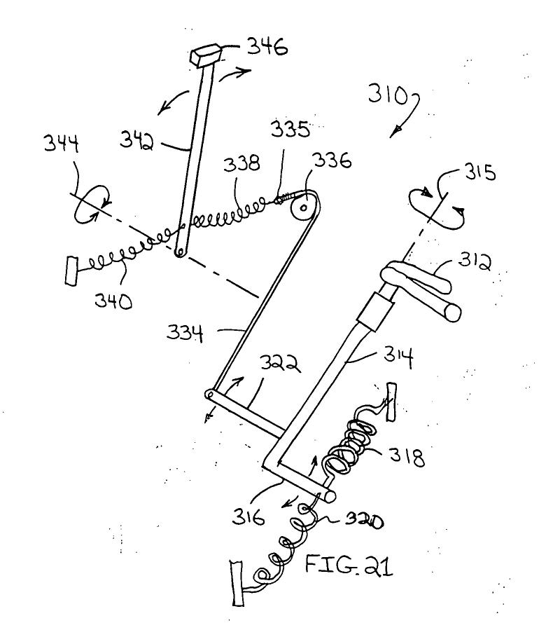

Still further systems for enabling the remote control of a physical simulation of a two-wheeled vehicle arrangement are depicted generally at 360 in FIGS. 23, 24, and 25. In FIGS. 23 and 24, first and second two-wheeled vehicles 362 and 364 are pivotally coupled to opposed edges of a first pivot member 366, which in this example comprises a flat panel. The two-wheeled vehicles 362 and 364 are disposed in a parallel relationship. A second pivot member 368 has a first end pivotally coupled to the first two-wheeled vehicle 362 in alignment with the longitudinal center of gravity thereof and a second end pivotally coupled to the second two-wheeled vehicle 364 in alignment with the longitudinal center of gravity thereof. Under this arrangement, the first and second two-wheeled vehicles 362 and 364 exhibit identical banking characteristics. A banking sensor 371 is disposed in relation to the first and second wheeled vehicles 362 and 364 for sensing the bank angle thereof. The banking sensor 371 can be of any effective type, such as a potentiometer. In this example, the banking sensor 371 is disposed to detect the angle between the first two-wheeled vehicle 362 and the first pivot member 366.

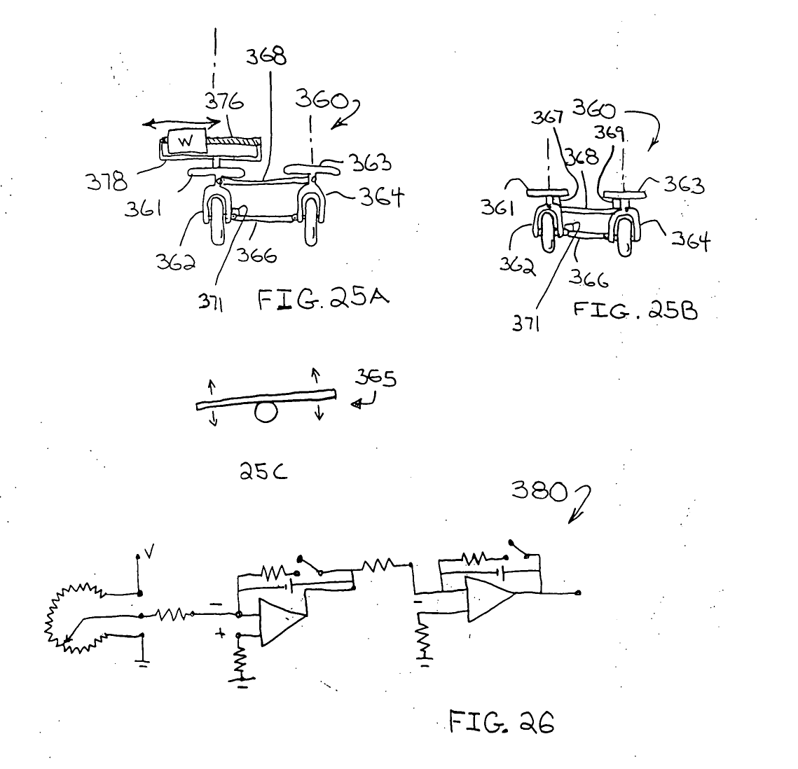

A servomotor 370 is retained relative to the first pivot member 366. A servo arm 372 has a proximal end driven by the servomotor 370 and a distal end pivotally coupled to a first end of a banking arm 374. Operation of the servomotor 370 can be controlled by use of an electrical circuit 380 as is depicted in FIG. 26. The electrical circuit 380 can be a double integrator circuit with a potentiometer and first and second reset switches that are open to allow operation of the servomotor 370 and close to reset.

A second end of the banking arm 374 is pivotally coupled to the second two-wheeled vehicle 364 in alignment with the longitudinal center of gravity thereof. Under this arrangement, the first and second two-wheeled vehicles 362 and 364 can be banked by a remote control arrangement 68, such as one of those shown in FIGS. 2 through 6B, that is in communication with the servomotor 370. Again, the remote control arrangement 68 can have an indicator wand 72 for providing the user with an immediate visual indication of the bank angle of the first and second two-wheeled vehicles 362 and 364.

The first and second two-wheeled vehicles 362 and 364 can have freely pivoting steering arrangements 361 and 363 respectively. With this, a user can bank the first and second two-wheeled vehicles 362 and 364 by exploitation of the servomotor 370, and the user can balance and maneuver the first and second two-wheeled vehicles 362 and 364 by the resulting pivoting of the first and second steering arrangements 361 and 363. The bank angle to which the servomotor 370 tilts the first and second two-wheeled vehicles 362 and 364 can correspond in radians to the lateral acceleration predicted as described herein expressed as a fraction of gravity.

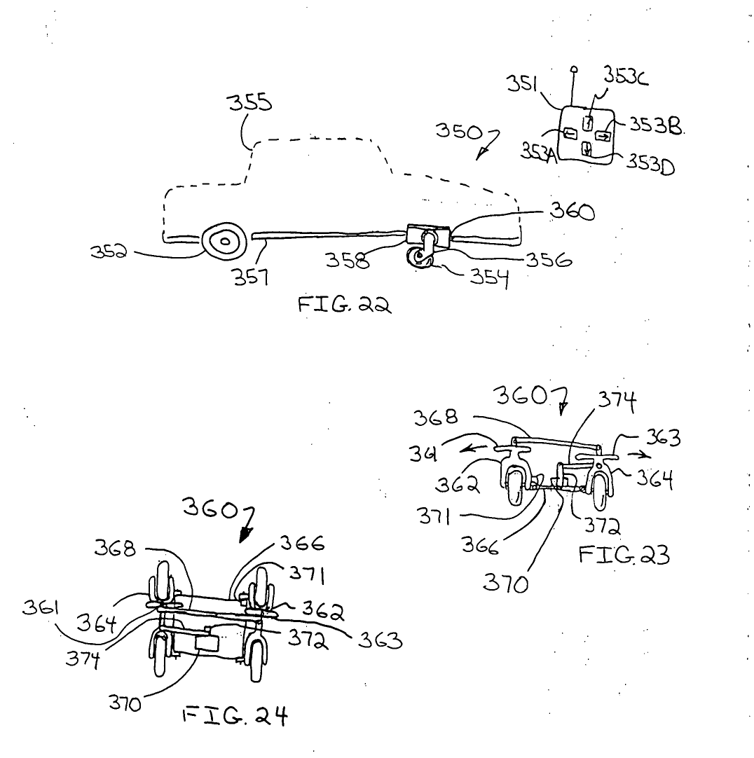

In the embodiment of the two-wheeled vehicle arrangement 360 of FIG. 25A, first and second two-wheeled vehicles 362 and 364 are again disposed in a parallel relationship for identical banking by first and second pivot members 366 and 368. In the present construction, however, the balance and banking of the first and second two-wheeled vehicles 362 and 364 can be controlled by a laterally moving weight W. The weight W can be laterally moveable under any effective construction. In this example, the weight W travels along a rod 376 by a threaded engagement therebetween. The rod 376 has first and second ends retained by a support framework 378 that is fixed to the first two-wheeled vehicle 362 in alignment with the longitudinal center of gravity thereof.

Although a laterally moving weight W is depicted only in relation to the first two-wheeled vehicle 362 in the present embodiment, it is readily within the scope of the present invention for a similar laterally moving weight W construction to be disposed in relation to the second two-wheeled vehicle 364. In either case, the weight W or weights W can be moved laterally to adjust the effective center of gravity of the two-wheeled vehicle 362 or vehicles 362 and 364. With this, the two-wheeled vehicles 362 and 364 can be balanced and maneuvered by a movement of the weight W or weights W.

The movement of the weight W or weights W can be controlled by a remote arrangement, which can include a means, such as a balancing platform as in FIG. 25C, for sensing a user's change in center of gravity, a steering arrangement as in FIGS. 2 through 6B, and/or any other effective control means. The depicted two-wheeled vehicle arrangement 360 can thus be controlled much in the same way that an actual rider would balance a vehicle during no-handed operation or by a combination of steering and balancing. Where the two-wheeled vehicle arrangement 360 is banked in a turn, the laterally moving weight W or weights W can be moved in a direction opposite to the turning of the steering arrangements 361 and 363 to resist the turning and, with sufficient movement, to return the first and second two-wheeled vehicles 362 and 364 to a vertical orientation and possibly beyond.

The embodiment of the two-wheeled vehicle arrangement 360 of FIG. 25B again has first and second two-wheeled vehicles 362 and 364 disposed in a parallel relationship for identical banking by first and second pivot members 366 and 368. It this embodiment, the balance and banking of the first and second two-wheeled vehicles 362 and 364 can be controlled merely by steering the first and second steering arrangements 361 and 363. The first and second steering arrangements 361 and 363 can be driven by first and second steering drives 367 and 369. The steering can thus be controlled by a remote arrangement, again as shown in FIGS. 2 through 6B, and/or any other effective control means. The depicted two-wheeled vehicle arrangement 360 can thus be controlled much in the same way that an actual rider would steer and balance a vehicle.

In one example of operation of the two-wheeled vehicle arrangement 360, the vehicles 362 and 364 can each be assumed to have a weight of one pound, a one-foot radius of gyration, a one inch of trail or caster, and an even weight distribution between the front and rear wheels. Control can be had through a linear, critically damped second order servo loop. Input from the steering arrangement can be received in instantaneous desired turning force measured in proportions of gravity. The torque on each steering arrangement 361 and 363 can be determined by Equation 12A below.

$$T = + \frac{1}{2 \sqrt{32}} \dot{θ} + \frac{1}{2} ( θ - S ) \qquad ( Equation 12 A )$$

Where,
T is the torque on each steering arrangement 361 and 363;
θ is the lean angle expressed in radians; and
S is the desired turning force expressed as a proportion of gravity.
   Remote Riding Control of Two-Wheeled Vehicle

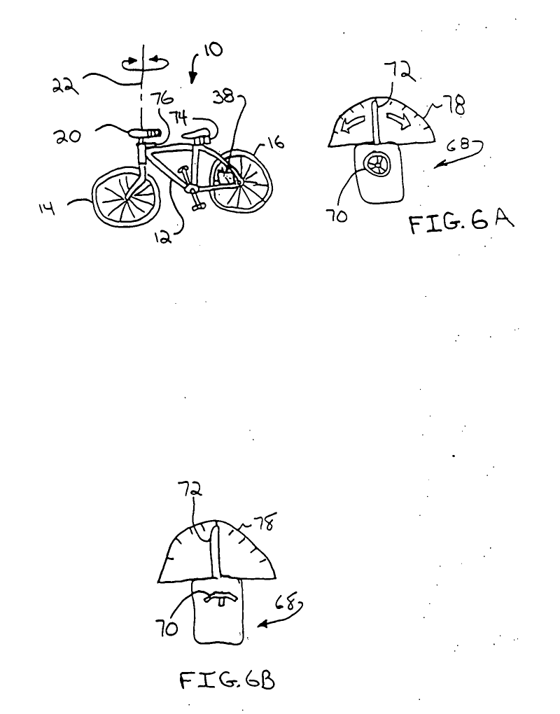

The control of a visually simulated two-wheeled vehicle and the remote control of a physical simulation of a two-wheeled vehicle undoubtedly present the user with appreciable advantages in learning, practicing, and enjoying two-wheeled vehicular function. However, other embodiments of the invention, which again can have their operation founded on the Theoretical Method of Operation described herein, can enable a user to exert control over an actual two-wheeled vehicle 10 such as that shown in FIG. 6A. There, the balance, banking, response, and other related performance characteristics of the two-wheeled vehicle 10 are entirely real in that the two-wheeled vehicle 10 is entirely freely moving and the performance of the vehicle 10 is dependent solely on the actual physics involved. The banking arrangement 35, the mobile platform 60, and all other simulative means are foregone. The two-wheeled vehicle 10 in this embodiment could be substantially any size whether in miniature, of standard size, or, albeit less likely, larger than standard size. As such, it is as if the person controlling the two-wheeled vehicle 10 is actually riding the same, although remotely.

The two-wheeled vehicle 10 can be controlled by a remote riding control unit 68, such as that included in FIG. 6A and indicated at 68 or that shown in FIG. 6B and again indicated at 68. In each case, the remote riding control unit 68 can have an indicator wand 72, which can be an actual wand or a visual representation thereof, for providing an indication of the bank angle θ_{z} of the two-wheeled vehicle 10 to better enable the person's control thereover. A graduated scale 78 can act as a backdrop for the indicator wand 72. A steering arrangement 70 is pivotally retained relative to the remote control riding unit 68. In FIG. 6A, the steering arrangement 70 comprises a steering wheel, and, in FIG. 6B, the steering arrangement 70 comprises a set of miniature handlebars. The two-wheeled vehicle 10 has a propulsion arrangement 38, which can be of any appropriate type, for propelling the two-wheeled vehicle 10 over a support surface. A steering torquer 76 can impart a steering torque on the steering arrangement 20 of the front wheel 14 to adjust its orientation relative to the frame 12. To facilitate the control of the two-wheeled vehicle 10, a bank angle θ_{z} sensor 74 can be operably associated with the two-wheeled vehicle 10. While a number of different bank angle θ_{z} sensors 74 would readily occur to one skilled in the art, one possible sensor 74 could comprise a sonar device.

In one manifestation of the invention, the control system, which can rely on the Theoretical Method of Operation disclosed herein, can enable a user to control the two-wheeled vehicle 10 by a simple pivoting or turning of the steering arrangement 70 with the control system providing the requisite torques on the steering arrangement 20 of the two-wheeled vehicle 10 to achieve the desired steering and other performance characteristics while maintaining the stability of the two-wheeled vehicle 10. Stated alternatively, the user can simply steer the steering arrangement 70 while the control system oversees the details of torquing the steering arrangement 20 to maintain the balance and stability of the two-wheeled vehicle 10. For example, where a user turns the steering arrangement 70 counterclockwise thereby indicating a desire that the two-wheeled vehicle 10 turn left, possibly at a given bank angle θ_{z}, the control system can induce the chain of events required to achieve that result. To do so, for example, the control system would cause the steering torquer 76 to impart a brief clockwise torque on the steering arrangement 20 to cause it to turn briefly to the right thereby to induce the two-wheeled vehicle 10 into a roll to the left. The control system would in due course cause the steering torquer 76 to impart a counterclockwise torque on the steering arrangement 20 to ease the two-wheeled vehicle 10 into the desired turn or bank angle θ_{z}. The two-wheeled vehicle 10 could then be assumed to reach the equilibrium described above in relation to the present inventor's Theoretical Method of Operation. The user could then impart further torques on the steering arrangement 70 to cause the control system to disturb the equilibrium. Of course, infinite control signal scenarios are possible with the basic premise being that the control system could exploit the Theoretical Method of Operation to maintain the two-wheeled vehicle 10 in stable motion. The control system can comprise a second order servo loop, which can be critically damped or possibly overdamped as it controls the steering and balance of the two-wheeled vehicle.

In an alternative manifestation of the invention, the control system's maintenance of the stability of the two-wheeled vehicle 10 could be dispensed with entirely or could operate only as a safety mechanism such that a user would be called upon to control every nuance of two-wheeled vehicle operation in seeking to control the two-wheeled vehicle 10 while maintaining its stability. With this, the user seeking to induce the left hand turn described above would be required actually to impart the clockwise torque to induce the roll and then the counter-clockwise torque to achieve stability, and the user simply seeking to maintain a straight traveling two-wheeled vehicle in stability would need to impart the corrective torques on the steering arrangement 70, and thus on the steering arrangement 20, that are inherently required to maintain a two-wheeled vehicle 10 in stable motion. The steering arrangement 70 could exhibit torques in proportion to or reproductive of the torques that would actually be produced by a steering arrangement in an actual vehicle undergoing the same motion. In controlling the two-wheeled vehicle 10, the user can have reference to the two-wheeled wheeled vehicle 10 and/or to the indicator wand 72 to perceive the present bank angle θ_{z} of the two-wheeled vehicle 10.

Under such an arrangement, one can assume that the two-wheeled vehicle 10 could undertake a maximum 0.5 G turning event. One can also assume an 18 inch wheelbase, a trail of 1.5 inches, a weight of 5 lbs, and a radius of gyration of 1 foot. The maximum angular acceleration can be calculated employing Equation 13 below.
\ddot{Θ}ₘₐₓ=32 ft/s²/1 ft (Equation 13)
For greater stability, one can operate under one-half of the maximum angular acceleration, which is 16 rad/s².

In the system controlled embodiment where one merely steers and the system ensures stability, a critically damped second order servo loop can be assumed to have an angular acceleration derived as set forth below in Equation 14.
\ddot{Θ}=−1 G(Θ−Θ_{c})−8\dot{Θ} (Equation 14)
Where,
T is the handlebar torque on the two-wheeled vehicle 10;
θ_{c} is the commanded angle (the desired angle).

In a system where the user entirely controls the steering and balance of the two-wheeled vehicle except for any backup provided by the system, the limits at which the system intervenes to prevent leaning beyond a predetermined limit (in this case approximately 30 degrees or 0.5 radians) are determined by Equations 15 and 16 below. In this system, the torque imparted on the steering arrangement 20 can be proportional to that imparted on the steering arrangement 28.

$$\begin{matrix}\dot{θ} > 0 : Limit = \dot{θ} < \sqrt{32 \cdot ( \frac{1}{2} - θ )} & ( Equation 15 ) \\ \dot{θ} < 0 : Limit = \dot{θ} > - \sqrt{32 \cdot ( θ + \frac{1}{2} )} & ( Equation 16 )\end{matrix}$$

Rider Controlled Two-wheeled Vehicle Motion Simulation With Mobile Platform

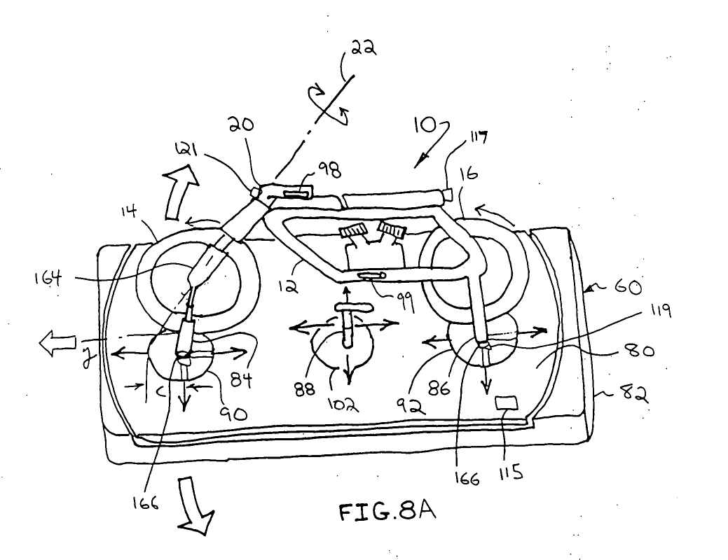

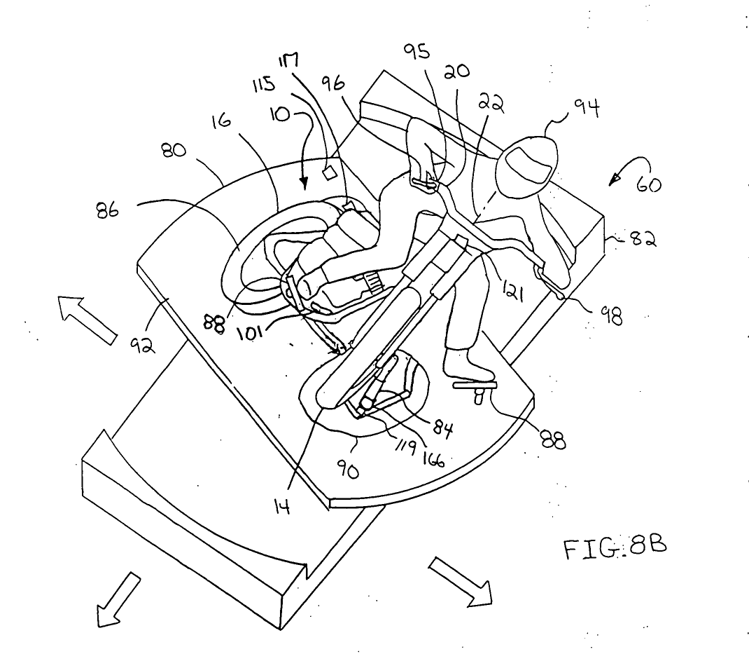

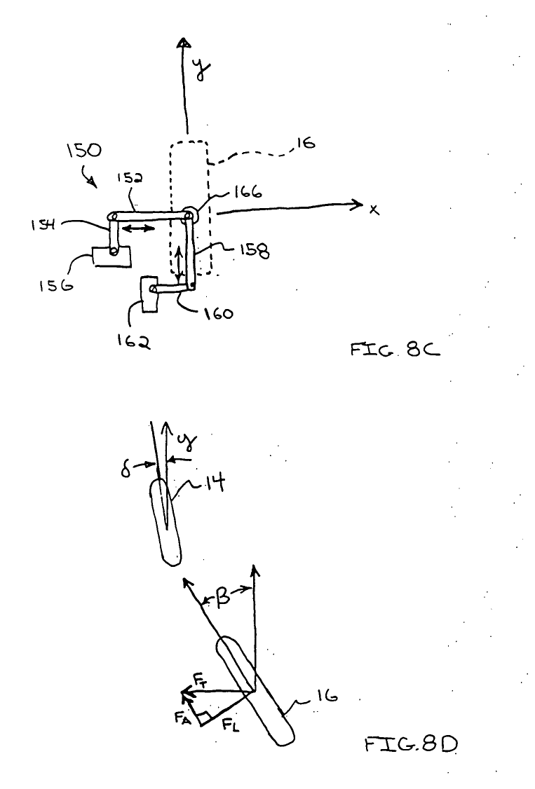

A further embodiment of the invention is depicted, for example, in FIGS. 8A and 8B in the form of a rider controlled two-wheeled vehicle 10 mounted on a mobile platform 60 for actually being ridden by a rider 94. In this example, the two-wheeled vehicle 10 simulates a flat tracker motorcycle, and the mechanical and control details of the embodiment have a number of aspects that can be considered to be particularly advantageous for simulating such a vehicle. It will be readily appreciated, however, that the particular two-wheeled vehicle 10 simulated can vary widely within the scope of the invention.

The two-wheeled vehicle 10 has simulative front and rear wheels 14 and 16 that can be rotatably retained relative to its frame 12. A steering arrangement 20 comprising handlebars pivots about a steering axis 22. An accelerator 95 is incorporated into a first handle portion of the steering arrangement 20 for enabling the rider 94 to impart a signal to the control system to impart a simulated acceleration to the two-wheeled vehicle 10, which could cause the rear wheel 16 to increase its angular velocity and/or cause the control system to calculate and accommodate what the acceleration would be in an actual two-wheeled vehicle and its effects on the performance of the simulative two-wheeled vehicle 10. The front and rear wheels 16 can be caused to rotate and change speeds of rotation to provide a most realistic simulation of motion and to create the gyroscopic forces that would be exhibited by the wheels 14 and 16 during that motion. Alternatively, the system could merely calculate the speeds, accelerations, and resulting effects that would actually derive from a spinning of the front and rear wheels 14 and 16. Additionally, a braking means, such as a hand braking lever 96 can be disposed on the steering arrangement 20 to enable the rider 94 to impart actual and simulated braking forces to be perceived and accommodated by the control system and, possibly, the front wheel 14 and, additionally or alternatively, the rear wheel 16. A foot brake 99 can also or alternatively be provided for providing actual and/or simulated braking to the rear wheel 16. A clutch lever 98 and a shifting lever 101 can cooperate to enable a rider to engage in a simulated shifting of gears of the two-wheeled vehicle.

The two-wheeled vehicle 10 is retained relative to the mobile platform 60 by means for enabling the two-wheeled vehicle 10 to tilt through bank angles θ_{z} relative to the platform 60 in simulation of actual vehicular motion and performance. In the depicted example, the means for enabling the two-wheeled vehicle 10 to be tilted comprises a forward support rod 84 that has a first end fixed to the steering fork 164 and a second end pivotally retained relative to the mobile platform 60, such as by a ball joint 166, along with a rearward support rod 86 that has a first end fixed to the frame 12 and a second end pivotally retained relative to the mobile platform 60, such as by a ball joint 166. The ball joint 166 can preferably be vertically and horizontally located such that the two-wheeled vehicle 10 would tilt about a roll axis y as it would in actual operation that is horizontally aligned with the plane of the two-wheeled vehicle and that is approximately equivalent in vertical location to what would be the height of the contact points of the front and rear wheels 14 and 16 with a support surface. The forward support rod 84 and the rearward support rod 86 and the associated ball joints 166 can be supported and moved by a quick response motion arrangement 150, which is depicted schematically in FIG. 8C.

As can be seen most clearly in FIG. 8C, the quick response motion arrangement 150 can have first and second motion portions respectively founded on a torquing motor 156 or 162. The torquing motor 156 drives a proximal control arm 154 that in turn drives a distal control arm 152. Similarly, the torquing motor 162 drives a proximal control arm 160 that in turn drives a distal control arm 158. The forward support rod 84 and the associated ball joint 166 and quick response motion arrangement 150 operate within the bounds of a support well 90 in the mobile platform 60. Likewise, the rearward support rod 86 and the associated ball joint 166 and quick response motion arrangement 150 operate within the bounds of a support well 92 in the mobile platform 60. Under this arrangement, the two-wheeled vehicle 10 is free to pivot about the roll axis y by use of the ball joints 166. The quick response motion arrangements 150, therefore, can impart forces along and between the x and y directions.

Those forces would, in turn, affect and create the operation of the two-wheeled vehicle 10, such as by creating and adjusting bank angles θ_{z} and the like in response to control inputs provided by the rider 94. In any case, the forward support rod 84 could be extensible and retractable to enable the two-wheeled vehicle 10 to be pitched to simulate a hill-climbing orientation. The ball joint 166 about which the forward support rod 84 pivots will preferably be disposed rearward of the point at which the axis of rotation 22 of the steering arrangement 20 would intersect the same horizontal plate such that a caster or trail is ensured so that the two-wheeled vehicle 10 can operate and be controlled pursuant to the Theoretical Method of Operation described herein.

With combined reference to FIGS. 8A and 8B, one can perceive that the mobile platform 60 can be formed by an upper platform 80 that is pivotally retained relative to a base platform 82. Under such an arrangement, the upper platform 80 can pivot relative to the base platform 82 to enable an accurate simulation of further two-wheeled vehicle riding conditions, such as the lateral sliding of a rear wheel 16 deriving from an intentional or unintentional loss of traction of the rear wheel 16 relative to a support surface. For example, with such a pivoting as is depicted in FIG. 8B, a rider 94 can realistically recreate the intentional kicking out of the rear end of a motorcycle that is integral to flat track motorcycle racing. The system can incorporate sensors, such as inertial sensors 115, for detecting the linear and angular accelerations of the upper platform 80 and, derivatively, the two-wheeled vehicle 10. The inertial sensors 115 could be coupled to the mobile platform 60 and/or directly to the two-wheeled vehicle 10. Weight distribution and the overall force of the two-wheeled vehicle 10 can be detected by any suitable means, including, by way of example, load cells 119 disposed at the bases of the forward and rearward support rods 84 and 86. Of course, there also can be means, such as a sensing unit 117 for sensing the bank angle θ_{z}, angle of incline, acceleration, and other parameters relating to the disposition and movement of the two-wheeled vehicle 10. The system would further detect the angular disposition, or angle of attack, of the front wheel 14 by a sensing unit 121. Of course, such sensors or detectors could be provided in a single unit or as multiple separate units.

The ability of the system to provide a user with a still more complete imitation of two-wheeled vehicle operation, foot members 88 can engage the feet of the rider 94 to sense any amount of force that the rider 94 might seek to apply to the support surface and, possibly, to impart a corresponding opposing force on the rider's foot. The system can sense the applied force by the rider's foot and can give that force a representative effect in the performance, such as the simulated sliding, of the two-wheeled vehicle 10. As FIG. 8A shows, the foot members 88 can extend from retaining wells 102. Alternatively, where greater motion may be necessary or desirable, the foot members 88 can be freely movable by being retained relative to the feet of the rider 94. In either case, the foot members 88 can incorporate extensible and retractable arrangements or other means for enabling movement for providing representative forces to the rider 94 through his or her feet.

As FIG. 8B depicts most clearly, the two-wheeled vehicle 10 of this embodiment can simulate the sliding out of the rear wheel 16 of the vehicle 10 as is commonly the case during flat tracker racing and the like. The system of the present invention can factor in the physics of such a maneuver as exemplified in FIG. 8D, which schematically depicts the general disposition of the vehicle 10 in FIG. 8B. There, the front wheel 14 has an angle of attack aligned with the path of travel y of the vehicle 10. The rear wheel 16 is slid out from that path of travel by an angle β either by excessive braking or acceleration. When the rear wheel 16 is so disposed, a total vector force F_{T} will act on the tire. The total vector force F_{T} represents the sum of what can be termed an acceleration force F_{A}, which can be positive, negative, or zero and which is directly parallel to the orientation of the rear wheel 16, plus the lateral force F_{L} acting on the rear wheel 16 as it slides over the support surface. Employing the same concept in relation to the front wheel 14, the lateral force F_{L} can be calculated to equal ((F_{T})(δ))/(0.1 rad) where δ is the slip angle. Where the absolute value of δ or β exceeds 0.1 rad (6 degrees), one can assume that the relevant wheel 14 or 16 follows the aforedescribed sliding or skid model. Where δ or β is less than 0.1 rad, then the system would calculate two proposed F_{L}'s, namely

$$\frac{{F}_{T} \cdot δ}{0.1 rad} or \frac{{F}_{T} β}{0.1 rad}$$

and \sqrt{F_{T}²−F_{A}²} (for each wheel) and then uses whichever is least. Employing this knowledge, the two-wheeled vehicle 10 can simulate actual vehicular motion still more closely.

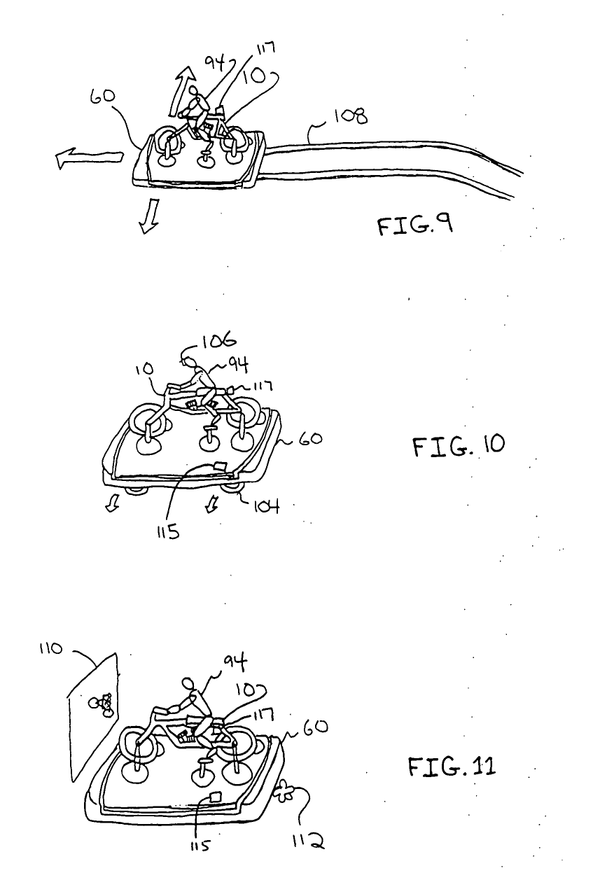

In any case, the mobile platform 60 can incorporate means for moving the mobile platform 60. As one skilled in the art will appreciate, the means for moving the mobile platform 60 could take substantially any form. For example, the means for moving the mobile platform 60 can comprise a means for moving the mobile platform 60 over a solid surface, such as wheels 104, which are preferably steerable, as is shown in FIG. 10. Alternatively or additionally, the means for moving the mobile platform 60 could comprise a means for moving the mobile platform 60 over a water surface, such as the propeller 112 depicted in FIG. 11. Still further, the means for moving the mobile platform 60 could comprise rails 108 as shown in FIG. 9. The simulation could be rendered still more realistic by a means for enabling a limited lateral movement of the mobile platform 60 relative to the rails 108. Under such an arrangement, the two-wheeled vehicle 10 could simulate two-wheeled vehicle motion in an amusement park or substantially any other environment.

In an even further possible refinement of the invention, the system could incorporate display means for providing a visual simulation to the rider 94 while he or she is experience a physical simulation of movement by operation of the two-wheeled vehicle 10 and the mechanisms associated therewith. For example, as FIG. 10 shows, the rider 94 could be provided with virtual reality goggles 106. As FIG. 11 shows, a rider 94 could alternatively be provided with a display screen 110. In either case, the display means can provide the rider 94 with a simulated scene through which he or she can seek to maneuver the two-wheeled vehicle 10.

With such a display means provided, the two-wheeled vehicle 10 could be used in one application for enabling a rider 94 to practice and learn the requirements necessary for maneuvering a two-wheeled vehicle during actual operation thereof in truly accurate virtual reality. For example, in one practice of the invention, motion could be simulated additionally by use of the display means. As such, apparent speed by use of the display means could supplement the actual speed and movement of the two-wheeled vehicle 10 and the platform 60. The mobile platform 60 could demonstrate limited movement while the display means gives the rider 94 the perception of moving at a high rate of speed, such as 50 mph, at which avoiding obstacles requires skill and experience of a level commonly not possessed by novice riders. A rider 94 presented with obstacles, control instructions or indications, or the like would be required to steer the simulated two-wheeled vehicle 10 to avoid the simulated obstacles and the like, which approach the rider 94 at the simulated speed. The rider 94 could, therefore, learn how to induce a turn in a given direction (i.e., by first turning in the opposite direction to induce vehicle roll and then counter-steering as necessary to achieve stable motion) while in the safety and repeatability of a simulated environment. In each application of this embodiment of the two-wheeled vehicle 10, the front and rear wheels 14 and 16 could rotate as they would at the simulated speed to give the gyroscopic and other effects that would actually derive therefrom.

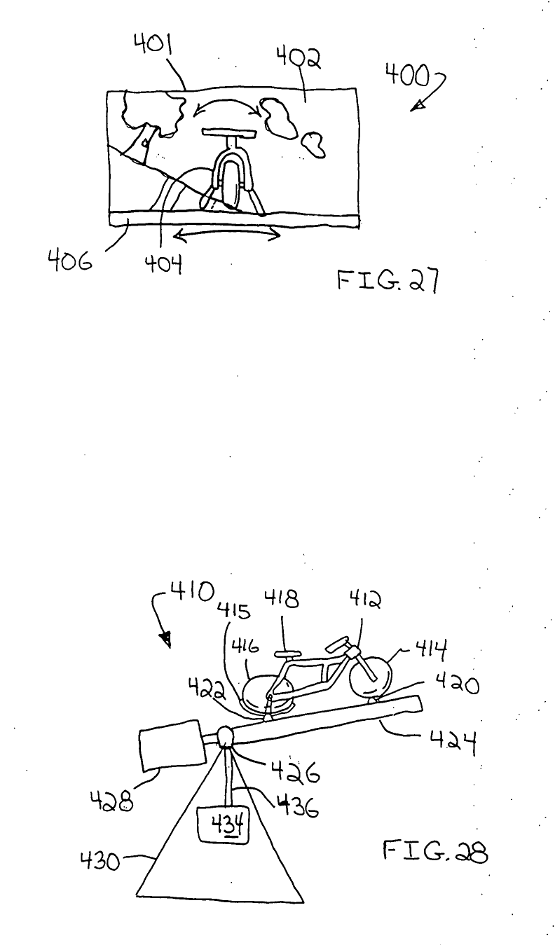

In any case, with such a two-wheeled vehicle 10 arrangement, a rider 94 can be provided with a realistic simulation of the movement of a two-wheeled vehicle 10, such as the motion of a flat tracker motorcycle over a ground surface. Advantageously, the rider 94 can gain such an experience without the skill and danger that are substantially inherent in flat tracker racing and similarly aggressive riding of a two-wheeled vehicle. By the combined effects of the quick responsive movements deriving from the quick response motion arrangements 150 and, possibly, the gross vehicular movements of the mobile platform 60, the system can impart on the rider 94 a realistic simulation of the forces that would be experienced during actual riding. For example, where a rider 94 twists the accelerator 95 to induce an accelerative effect on the two-wheeled vehicle 10, the quick response motion arrangements 150 can induce a quick response movement of the two-wheeled vehicle 10 by moving the ball joints 166 and, therefore, the support rods 84 and 86 within the retaining wells 90 and 92 to give the rider 94 a perception that the two-wheeled vehicle 10 has begun accelerating. Substantially simultaneously, the mobile platform 60 can be induced into motion to continue imparting the perception of acceleration in a gross movement. When possible without substantially interfering with the desired simulation, the forward and lateral support rods 84 and 86 can return to their original or other dispositions to enable the greatest latitude in subsequent quick response movement. Furthermore, with the two-wheeled vehicle 10 in simulated motion, a rider 10 who turns the steering arrangement 20 will induce the quick response motion arrangements 150 into operation through the control system to cause them to impart corresponding lateral forces on the ball joints 166, which represent the contact points of the two-wheeled vehicle 10 with the support surface. The applied forces will yield the torques, angular speeds and accelerations, and bank angles θ_{z} that would be experienced in an actual vehicle at the simulated speeds and movements. Of course, those applied forces will preferably be determined by the control system in reliance on the Theoretical Method of Operation set forth herein to yield the correspondingly predictable vehicular responses. Turning to FIG. 27, a simulation arrangement 400 is depicted wherein a two-wheeled vehicle 404 is fixed in a vertical but laterally moveable disposition in relation to a support structure 406. A visual display, which can be an actual display screen 401, virtual reality goggles, or any other display means for displaying a scene 402 can be disposed for viewing by a rider. The scene 402 on the display screen 401 can be pivotable thereby to demonstrate a pivoting of the scene in relation to the rider. In combination with lateral movement provided by the support structure 406, a rider who remains vertical can nonetheless experience much of the visual experiences and physical forces that would be experienced during actual riding.

In certain practices of the invention, the lateral forces experienced during actual two-wheeled vehicular operation can be simulated more accurately by calibrating the lateral shifting of the two-wheeled vehicle 404 to impart a lateral acceleration expressed as a fraction of gravity corresponding to the simulated bank angle of the two-wheeled vehicle 404 expressed in radians. Ideally, all or substantially all visual input to the rider other than the scene 402 on the display screen 401 will be excluded. With this, the senses of the rider can be effectively caused to perceive actual vehicle maneuvering.

As FIG. 28 shows, alternative embodiments of the invention could simulate not only the forces planar x and y forces but also the vertical forces that a rider would normally experience in climbing and descending. In FIG. 28, a motion simulation arrangement is depicted generally at 410. The motion simulation arrangement 410 employs a cantilevered support arm 424 to support a two-wheeled vehicle 412 that has a front wheel 414 and a rear wheel 416 retained relative to a frame 418. The cantilevered support arm 424 pivots and rotates on a fulcrum 426 in relation to a support structure 430. A drive motor 434 can pivot and rotate the cantilevered support arm 424 through a drive arrangement 436. A counterbalance 428 at least partially offsets the weights of the support arm 424, the vehicle 412, and any rider.

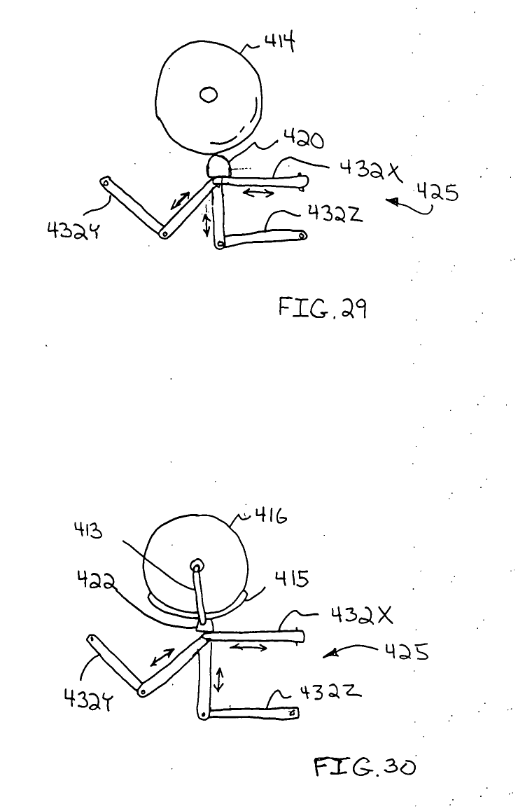

The front wheel 414 is retained at a single support location 420, and the rear wheel 416 is retained at a single support location 422. As is shown in FIGS. 29 and 30, each support location 420 and 422 is coupled to a three-dimensional motion simulation arrangement 425. The three-dimensional motion simulation arrangements 425 can impart motion on the respective single support locations 420 and 422 in x, y, and z directions by use of an x-direction motion portion 432X, a y-direction motion portion 432Y, and a z-direction motion portion 432Z. Each motion portion 432X, 432Y, and 432Z can be powered by a fast reaction, low inertia motor arrangement (not shown) for enabling the rapid movements and responses required for accurate simulation of two-wheeled vehicular motion. The movement of the cantilevered support arm 424 can be controlled by a relatively slower reaction motor arrangement (not shown).

With this the three-dimensional motion provided by the motion simulation arrangements 425 and by a pivoting of the cantilevered support arm 424 can provide an accurate simulation of substantially all forces that would be experienced by a rider during actual vehicle movement, including as he or she would experience in ascending or descending a hill. The motion simulation arrangement 410 would do so by replacing the actual contact between vehicle wheels with single points of motion that are moveable in three-dimensions.

A visual simulation of three-dimensional vehicular movement such as the display screen 401 of FIG. 27, virtual reality goggles, or any other display means for displaying a scene 402 can be disposed for viewing by a rider. Again, all or substantially all visual input to the rider other than the scene 402 on the display screen 401 will be excluded for a most convincing simulation of three-dimensional movement. With this, three-dimensional hill climbing and descending and other vehicle movement can be realistically perceived by a rider both visually and physically.

To further the accurate simulation of hill climbing and descending, the single support location 422 of the rear wheel 416 can be moveable along a bottom portion of the wheel 416, such as along a track 415 by operation of a pivot arm 413. With this, the single support location 422 can, for example, move rearward and upward in relation to the frame 418 when a simulation of a wheelie is desired. With this, the operation of the forces exhibited by the three-dimensional motion simulation arrangement 425 can be located as would be experienced during actual riding.

Gyroscopically Stabilized Two-Wheeled Transportation Vehicle

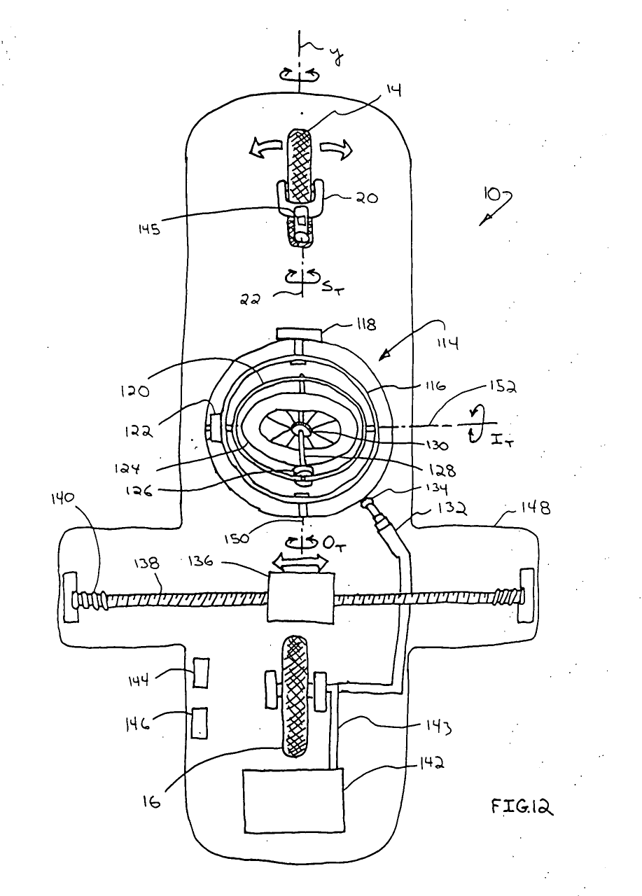

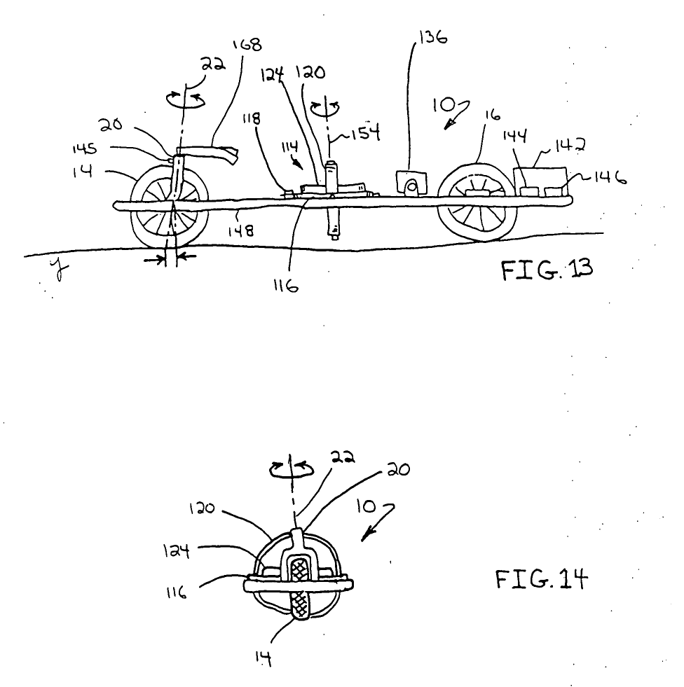

The present invention can alternatively be embodied in a two-wheeled transportation vehicle 10 as is depicted schematically in FIGS. 12 through 14. There, the two-wheeled vehicle 10 is founded on a chassis 148 that rotatably retains front and rear wheels 14 and 16. The front wheel 14 is retained by a steering arrangement 20 to pivot about a steering axis 22. The steering arrangement 20 can be directly or indirectly controlled by a steering control 168, which could comprise a set of handlebars, a steering wheel, or any other appropriate arrangement. A propulsion arrangement 142 provides propulsive power to the rear wheel 16 through a force transmission arrangement 143. The two-wheeled vehicle 10 can be considered to travel along the depicted y axis and can, in certain practices of the invention, be deemed to roll about the y axis as well such that the y axis can be considered to be the roll axis of the two-wheeled vehicle 10.

A stabilizing gyroscope 114 can be retained relative to the chassis 148 for imparting stabilizing torques on the two-wheeled vehicle 10 as will be described more fully herein. The gyroscope 114 could vary within the scope of the invention. In this example, the gyroscope 114 comprises a two-gimbaled arrangement. An outer gimbal 116 is coupled to the chassis 148 to pivot about an outer gimbal axis 150 that is parallel to the roll axis y. An inner gimbal 120 is coupled to the outer gimbal 116 to pivot about a gimbal axis 152 that is perpendicular to the gimbal axis 150 of the outer gimbal 116 and, therefore, perpendicular to the roll axis y of the two-wheeled vehicle 10. A gyro wheel 124 is rotatably retained relative to the inner gimbal 120 by a spindle 128 with an axis of rotation 154 perpendicular to the gimbal axis 152 of the inner gimbal 120.

An outer gimbal torquer 118 can torque the outer gimbal 116. An inner gimbal torquer 122 can torque the inner gimbal 120. A gyro wheel rotation unit 126 can maintain and adjust an angular velocity of the gyro wheel 124. In certain embodiments, the gyro wheel rotation unit 126 could be the sole means for bringing the gyro wheel 124 up to a desired angular velocity and for otherwise adjusting and maintaining any angular velocity. Alternatively, the gyro wheel 124 could be initially and/or periodically accelerated by a supplementary rotation means. For example, in the embodiment of FIG. 12, the propulsion arrangement 142 for the overall two-wheeled vehicle 10 could additionally be employed to provide an initial angular velocity to the gyro wheel 124, such as by a means for temporarily producing a driving engagement between the propulsion arrangement 142 and the gyro wheel 124. Of course, numerous different means could be conceived of by one skilled in the art after reading this disclosure. All such means are within the scope of the present invention. In this example, the means comprises an extensible and retractable drive arm 132 with a drive gear 134 disposed at a distal end thereof that is driven by the propulsion arrangement 142 in combination with a driven gear 130 fixedly retained relative to the gyro wheel 124 and/or the spindle 128.

An example of such an arrangement can be provided as follows. The gyro wheel 124 has a mass of 200 pounds, a 1 foot radius, and a rim speed of 320 feet/sec, which equals an angular speed of 320 rad/s. The energy in the flywheel is (200 lbs)(320 ft/s/8)²=320,000 ft lbs of energy. Assuming a propulsion arrangement 142 of 20 horsepower, the gyro wheel 124 can be revved to full speed in (320,000 ft lb)/(11,000 ft lb/s)=30 seconds.

To establish an analysis of whether such a system would tolerate a worst case (or most demanding) test of having the vehicle 10 disposed in a 1 G turn in a first direction and then seeking to have the vehicle 10 turn to a full 1 G turn in the opposite direction instantaneously, one can calculate with the following characteristics: a vehicle mass of 600 pounds centered 1 foot off of the support surface; a ballast weight of 200 pounds centered at 1.5 feet off of the support surface; a 6 foot ball screw or drive rod 138; the vehicle 10 is initially leaned 0.3 radian; maximum ballast acceleration is 32 ft/s²; maximum gyro torque is 3,000 ft lbs; and ballast is initially disposed fully to the left. The initial torque necessary to maintain lean angle is calculated as follows: 600 ft lb from ballast position+300 ft lb from ballast height+300 ft lb from ballast acceleration+600 ft lb from mass of vehicle at 1 foot+300 ft lb from vehicle at 0.3 radian lean˜=2,100 ft lb. Therefore, this leaves a surplus 900 ft lbs for producing an angular acceleration of the vehicle 10 about the roll axis. When ballast fully extended initially, the moment of inertia initially will be 600 pounds at 1 foot from the vehicle+200 pounds at 3.5 feet from the ballast giving approximately 2,000 lb ft². Dividing the surplus torque of 900 ft lbs by the moment of inertia of 2,000 lb ft² and multiplied by gravity or 32 ft/s² gives approximately 14 rad/s². With this, one can assume that the vehicle 10 can withstand the demanded change in disposition and will reach a vertical center position in approximately 0.25 seconds and a steady state 1 G turn in approximately 0.5 seconds. The ballast 136, which travels slightly slower, will take approximately 0.75 seconds to reach the right side of the vehicle 10.

The balance, stability, and maneuverability of the two-wheeled vehicle 10 can be further achieved and maintained by a laterally movable ballast 136. The ballast 136 could, of course, be of any effective size, weight, and configuration. Also, the means for laterally moving the ballast 136 could be of any functional type. In the depicted embodiment, the means for laterally moving the ballast 136 comprises a drive rod 138 disposed perpendicularly to the roll axis y of the two-wheeled vehicle 10 across the chassis 148. The means for selectively reciprocating the ballast 136 along the drive rod 138 could, for example, comprise a threaded engagement therebetween in combination with a means for rotating the drive rod 138 and/or all or part of the ballast 136. Resiliently compressible members 140 could be disposed at the opposed ends of the drive rod 138 for providing any necessary cushioning.

To facilitate the control, maneuverability, and stability of the two-wheeled vehicle 10, sensors can be provided to perceive, for example, the bank angle θ_{z}, roll and roll acceleration rates, and other performance characteristics and conditions of the two-wheeled vehicle. For example, in one embodiment, the two-wheeled vehicle 10 can have a vertical gyro 144 to sense the bank angle θ_{z} and a rate gyro 146 to sense roll and roll acceleration rates. Again, these and further sensors could be incorporated into a single unit or as multiple units.

Another possible embodiment of the gyroscopically stabilized two-wheeled vehicle 10 is depicted in FIG. 10. There, the two-wheeled vehicle 10 takes the form of a motorcycle. A vertical gyro 144 and a rate gyro 146 could again indicate the bank angle θ_{z} and roll and roll acceleration rates. A stabilizing gyro 114 could again be included. In this embodiment, however, the stabilization gyro 114 could be sized and controlled to provide full stability to the two-wheeled vehicle 10. Alternatively, it could be sized and controlled merely to provide assistive torques as the rider seeks to maintain the two-wheeled vehicle 10 in balance and control.

In operation, the control system can employ the stabilization gyro 114 and, if necessary, the ballast 136 to provide stability and maneuverability to the two-wheeled vehicle 10, ideally exploiting the Theoretical Method of Operation described herein. In one operation of this embodiment of the two-wheeled vehicle 10, the control system can exploit the stabilization gyro 114 and the ballast 136 to cause the two-wheeled vehicle to maintain a generally upright orientation such that it will handle as though it were a four-wheeled car. The system can employ the vertical gyro 144 to sense the bank angle θ_{z} and the rate gyro 146 to sense roll and roll acceleration rates and can impart any necessary force by use of the stabilizing gyro 114 to maintain the two-wheeled vehicle 10 in a generally vertical disposition. Where necessary, the system can additionally move the ballast 136 to change the effective center of gravity of the two-wheeled vehicle 10 to further affect the vehicle's balance and to minimize the force demanded of the stabilizing gyro 114. The two-wheeled vehicle 10 can provide a force feedback to the user through the steering control 168 by causing or allowing the steering control 168 to exhibit a steering torque proportional to the lateral forces being experienced relative to the front wheel 14.

Alternatively, the control system can generally allow the two-wheeled vehicle 10 to operate in what can be termed a motorcycle-handling embodiment where the vehicle 10 banks and rolls as one would expect of a typical two wheeled vehicle devoid of a stabilizing gyroscope 114. In such an embodiment, the stabilizing gyroscope 14 and, possibly, the ballast 136 could be induced to intervene and provide the two-wheeled vehicle 10 with stabilizing or performance assistance only when necessary to maintain or return to normal two-wheeled vehicular operation. Stated alternatively, the stabilizing gyroscope 14 and the ballast 136 could be employed only when the two-wheeled vehicle 10 demonstrates a deviation from expected banking or other performance characteristics and responses. The system could employ a mathematical model to predict what performance characteristics and responses should be demonstrated in each given circumstance. For example, the system can predict, such as by use of the Theoretical Method of Operation described herein, what roll rate or acceleration should be experienced during a coordinated turn, in response to a torquing of the steering arrangement 20, as a result of a change in weight distribution, and/or any other possible situation or input. Where the roll rate or roll acceleration does not match the predicted result, the system can initiate the stabilizing gyro 114 and/or the ballast 136 to impart corrective action.

A number of exemplary conditions can be described where a deviation from expected operation would occur and would induce the intervening operation of the stabilizing gyro 114 and/or the ballast 136. Under what can be termed Abnormal Condition A, the two-wheeled vehicle 10 is in a turn at a given bank angle. The control system of the present invention, which can incorporate an inertial platform, senses a roll acceleration happening to the two-wheeled vehicle 10 while no torque is being applied to the steering arrangement 20 by the vehicle occupant. Bearing in mind the equilibrium predicted by the Theoretical Method of Operation, the roll acceleration can be assumed to be symptomatic of a slippage of the two-wheeled vehicle 10. The system then can trigger a righting torque by the stabilizing gyro 114 until the system senses that the two-wheeled vehicle 10 is operating as expected, which indicates a steady state turn at the traction available.

Under what can be considered Abnormal Condition B, a two-wheeled vehicle 10 can be assumed to be leaned in a turn with the vehicle's occupant wishing to come out of the turn. The occupant would then impart a torque on the steering arrangement 20 to seek to cause the vehicle 10 to turn deeper into the turn. While such an action should induce a roll acceleration tending to right the vehicle 10, it does not under Abnormal Condition B. Such a failure will be demonstrated as a roll rate that is incongruous with that predicted by the control system. The system can, therefore, assume that the front wheel 14 has begun to slip. The system can then intercede with the operation of the stabilizing gyro 114 to provide a righting torque to achieve the desired result. The system can perceive the roll rate that was sought based on the torquing of the steering arrangement 20 and can cause the vehicle to achieve that roll rate. In certain cases, the system could additionally resist allowing the occupant to steer undesirably still deeper into the turn as can sometimes be the response of an occupant experiencing such slipping.

In Abnormal Condition C, a two-wheeled vehicle 10 is excessively braked or accelerated thereby causing a loss in traction in one or both wheels 14 and/or 16. Such a loss in traction would present itself in the form of a roll rate increase without an occupant's corresponding torquing of the steering arrangement 20. In response, the system can induce the stabilizing gyro 114 to impart a corrective torque, whether to roll the vehicle 10 to a vertical disposition, to place the vehicle 10 in the pre-slip bank position, or something in between.

Finally, in Abnormal Condition D, the vehicle 10 experiences what is commonly referred to as high siding. In high siding, one or both wheels 14 and/or 16 catches or otherwise experiences a sharp increase in lateral force thereby inducing a rapid, normally righting, roll acceleration. The system can induce the stabilizing gyro 114 to impart a torque minimizing or eliminating unintentional roll.

Vehicle Performance Control by Caster Banking

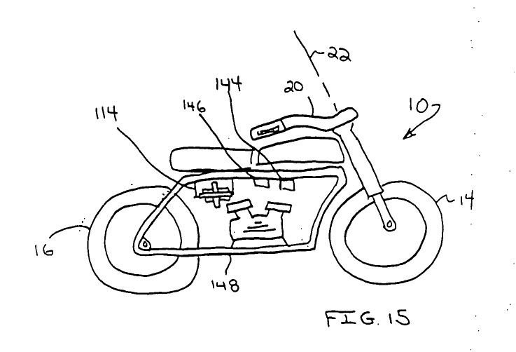

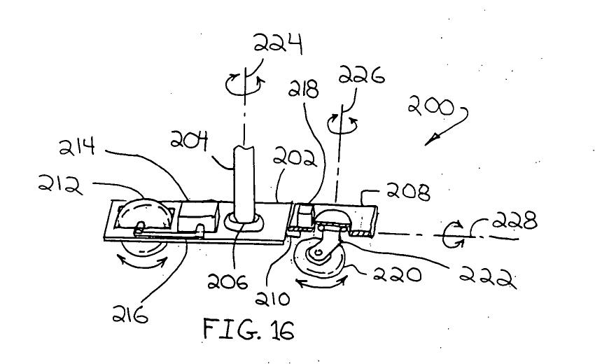

With reference to FIGS. 16 through 22, further embodiments of the invention are shown where vehicle performance control is accomplished by caster banking. A kart 230 employing two front wheeled trucks 200A and two rear wheeled trucks 200B in place of traditional front and rear wheels is shown in FIG. 17 while a rear wheeled truck 200 is shown alone in FIG. 16. With reference to FIG. 16, the rear wheeled truck 200 can be seen to have a front platform 208 and a rear platform 202. A support rod 204 has a proximal end (not shown) for being fixed to a vehicle as shown in FIG. 17 and a distal end pivotally coupled to the rear platform 202 by, for example, a ball joint 206.

The front and rear platforms 208 and 202 are coupled by a pivot coupling such that the front platform 208 is pivotable in relation to the rear platform 202 about a longitudinal axis 228. A servomotor 218 or other drive means can thus induce a selective banking of the front platform 208 in relation to the rear platform 202. A caster wheel 220 is rotatably retained in relation to a caster 222, and a caster 222 with a caster wheel 220 is rotatably retained relative to the front platform 208. A rear wheel 212 is rotatably retained in relation to the rear platform 202. The rear wheeled truck 200 in FIG. 16 can be seen to include a motor 214 for propelling, and possibly braking, the rear wheel 212 through a drive arrangement 216. With further reference to FIG. 17, one can see that the front wheeled trucks 200A are substantially similar to the rear wheeled trucks 200B except that the motor 214 and the drive arrangement 216 can be foregone.

Under this arrangement, a banking of the front platform 208 will induce a steering of the caster 222 and caster wheel 220. The steering of the caster 222 and caster wheel 220 will produce a resultant steering of the rear wheel 212 and the wheeled truck 200 in general. More particularly, when viewed in rear elevation a counter-clockwise camber of the front platform 208 will thereby yield a turn to the left of the wheeled truck 200 while a clockwise camber of the front platform 208 will yield a turn of the wheeled truck 200 to the right.

In FIG. 17, the front and rear wheeled trucks 200A and 200B are retained relative to a kart frame 234 by dedicated support rods 204 for each. An occupant seat 256 is supported by the frame 234, and a steering arrangement 224 is operably associated with the frame 234 and the front and, possibly, the rear wheeled trucks 200A and 200B. An accelerator pedal 232 is disposed for operation by a user's left foot, and a brake pedal 230 is disposed for operation by a user's right foot. The accelerator pedal 232 and the brake pedal 230 are in operable association with the rear and, possibly, the front wheeled trucks 200B and 200A for inducing an acceleration or braking of the rear wheels 212 of the wheeled trucks 200A and 200B. With this, a steering of the steering arrangement 224 can induce a cambering of the front platforms 208A and, possibly, 208B of the front and, possibly, the rear wheeled trucks 200A and 200B thereby to induce a steering of the kart 230 in general.

Under normal performance conditions, the kart 230 could perform in a traditional manner, such as by steering with the front wheeled trucks 200A and having the rear wheeled trucks 200B maintain an angle of attack in alignment with the longitudinal path 236 of the kart 230. Advantageously, however, the kart 230 can simulate a sliding out or loss of traction of the front, rear, or both portions of the kart 230 by a selective cambering of the front platforms 208A and/or 208B. For example, as is shown in FIG. 18, where a kart 230 has exceeded predetermined performance parameters, the front and/or rear wheeled trucks 200A and 200B can be steered away from the longitudinal orientation 236 of the kart 230 to achieve a skidding orientation 238 where the angle of attack of the wheeled trucks 200A and 200B depart from the longitudinal orientation of the kart 230. Sensors 215A and 215B can sense the angle of attach of the wheeled trucks 200A and 200B in relation to the kart frame 234.

With this, an operator can experience a simulated sliding of part or a portion of the kart 230 over a support surface. The kart 230 can thus simulate travel over widely varied surfaces with widely varied coefficients of friction. For example, the kart 230 can simulate travel over ice, snow, mud, pavement, gravel, or any other support surface with an accurate or scaled representation of the performance characteristics that would be experienced over each. The front and/or rear wheeled trucks 200A and 200B can be triggered to simulate a loss of traction in response to excessive braking, acceleration, and/or steering. Such simulations could advantageously be achieved without substantially stress on the kart 230, without undue wear on the wheels 212 and 220, and without undue losses in stability.

The kart 230 can follow the slip model described in relation to the two-wheeled vehicle 10 of FIGS. 8A through 8D. By means that would be obvious to one skilled in the art after reading this disclosure, corresponding cambering and braking and acceleration forces can be imparted to the front and rear wheeled trucks 200A and 200B. With this, an accurate or scaled replication could be achieved of the performance that the kart 230 would exhibit over varied support surfaces. A torquing motor 231 can be operably associated with the steering arrangement 224 for providing the user with a simulation of the proportional steering torque that would be experienced during operation of a traditional vehicle. The torque applied to the steering arrangement 224 can be based at least in part on the difference between the angle to which the steering arrangement 224 is turned as compared to the angle of attack of the front wheeled trucks 200A.

The camber angle expressed in radians of the platform 208 of the rear wheeled truck 200B can be determined as in Equation 17 below assuming a maximum slip angle of 0.1 radians. The acceleration of the rear wheeled trucks 200B, whether positive or negative, can be calculated mathematically for any given angle to which the rear wheeled trucks 200B are turned in relation to the kart frame 234 pursuant to Equation 18 below. It can be assumed under the Theoretical Method of Operation that a lateral force measured as a proportion of gravity will be produced by a given camber angle expressed in radians.
For −0.1<θ<0.1 (Equation 17)
Ψ=−10fθ if |10fθ|<√(f²−A_{K}²)
Ψ=−√(f²−A_{K}²) if |10fθ|>√(f²−A_{K}²) and θ>0
Ψ=√(f²−A_{K}²) if |10fθ|>(f²−A_{K}²) and θ<0
For θ<−0.1
Ψ=−A_{K} sin θ+√(f²−A_{K}²)cos θ
For θ>−0.1
Ψ=−A_{K} sin θ−√(f²−A_{K}²)cos θ
For −0.1<θ<0.1 (Equation 18)
A_{T}=A_{K}(1−|θ|)
For θ<−0.1
A_{T}=A_{K} cos θ+√(f²−A_{K}²)sin θ
For θ>−0.1
A_{T}=A_{K} cos θ−√(f²−A_{K}²)sin θ
Where,
θ is the angle of attack of the rear wheeled truck 200B in relation to the longitudinal orientation of the kart 230 and is negative when turned left and positive when turned right;
Ψ is the angle to which the platform 208 is cambered when viewed in rear elevation;
A_{K} is the longitudinal acceleration of the kart 230; and
A_{T} is the acceleration, which can be positive or negative, of the rear wheeled trucks 200B.

In relation to the front wheeled trucks 200A, the camber angle expressed in radians of the platform 208 can be determined as in Equation 19 below. The acceleration of the front wheeled trucks 200A, whether positive or negative, can be calculated mathematically for any given angle to which the front wheeled trucks 200A are turned in relation to the kart frame 234 pursuant to Equation 20 below.
For −0.1<Φ<−0.1 (Equation 19)
Φ=−10fΦ
For Φ<−0.1
Ψ=f cos Φ
For Φ>0.1
Ψ=−f cos Φ
For Φ<−0.1 or Φ>0.1 (Equation 20)
A_{T}=−f|sin Φ|
For Φ>=−0.1 or Φ<=0.1
A_{T}=0
Where Φ is the difference between the angle to which the steering arrangement 224 is turned and the angle of attack of the front wheeled truck 200A.

The torque to be exhibited at the steering arrangement 224 for realistic simulation of traditional vehicle performance can be determined as in Equation 21 below.
For −0.1<Φ<0.1 (Equation 21)
S_{T}=10fΦ
For Φ<−0.1
S_{T}=f cos Φ
For Φ>0.1
S_{T}=−f cos Φ
Where S_{T} is the steering torque with one unit of steering torque equaling one unit of gravity and f is the assumed coefficient of friction of the support surface.

In the foregoing, the longitudinal acceleration A_{K} of the kart 230 is assumed to be positive if accelerating and negative if decelerating and corresponds to the thrust forward divided by the downward force of the vehicle 250. The acceleration A_{T} of the rear wheeled trucks 200B is also positive if accelerating and negative if braking and correspondes to the forward thrust of the rear wheeled truck 200B divided by the downward force on the same.

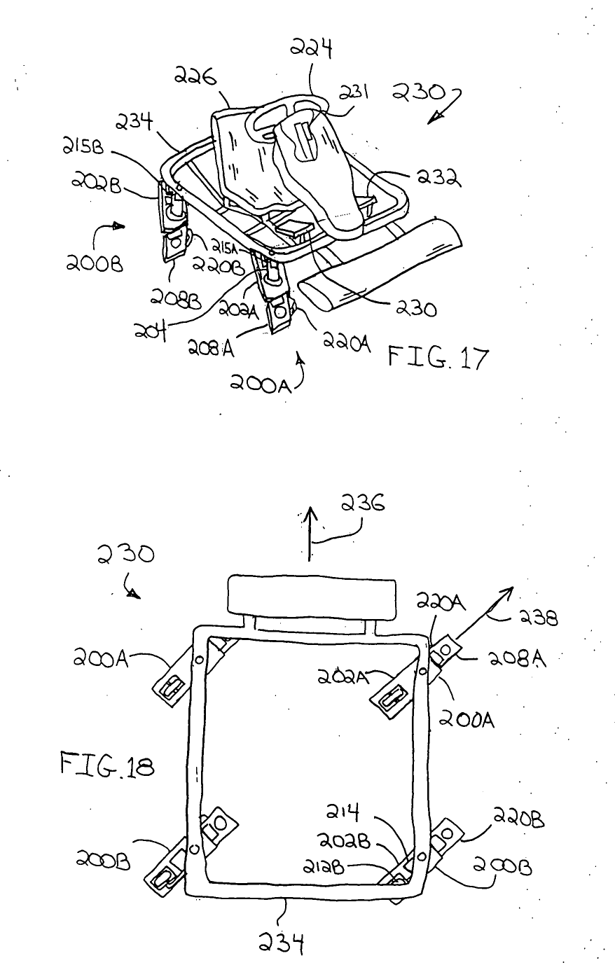

As FIG. 19A shows, wheeled trucks could alternatively be employed in replacement of the front and rear wheels of what would otherwise be a two-wheeled vehicle. The vehicle 250 in FIG. 19 has a front wheeled truck 262 coupled to a vehicle frame 252 in replacement of a front wheel and a rear wheeled truck 264 in replacement of a rear wheel. The front wheeled truck 262 is coupled to a lower steering member 260 at a ball joint 265, and the rear wheeled truck 264 is coupled to a rear support rod 257 of the frame 252 at a ball joint 275. The vehicle 250 has a seat 254 fixed to the frame 252. A steering arrangement 256 with an upper steering member 258 is pivotally coupled to the frame 252 by a steering sleeve 255. The lower steering member 260 is orthogonally fixed to the upper steering member 258 to establish a caster distance in relation to the front wheeled truck 262.

The front wheeled truck 262 essentially comprises two front wheeled trucks 200A of the embodiment of FIGS. 17 and 18 joined with a single platform 259. As such, the front wheeled truck 262 has two rear wheels 266 rotatably retained in relation to the platform 259 and two front caster wheels 268 rotatably retained relative to casters 270. The casters 270 are rotatably coupled to platforms 272, which, in turn, are pivotally coupled to the platform 259 by a pivot axis 276. The platforms 272 can be cambered in relation to the platform 259 by drive motors 274, which can comprise servomotors. With this, a selective cambering of the platforms 272 will yield a steering of the caster wheels 268 and a resultant steering of the front wheeled truck 262. The steering of the front wheeled truck 262 can be used to maneuver and balance the vehicle 250 and to simulate losses in traction as described herein. No torque need be added to the steering arrangement 256.

The rear wheeled truck 264 is essentially comprises two rear wheeled trucks 200B of the embodiment of FIGS. 17 and 18 joined with a single platform 261. First and second rear wheels 280 are rotatably retained relative to the platform 261 and are powered and braked by drive motors 278 through respective drive arrangements 276. Two front caster wheels 282 are rotatably retained relative to casters 284, which are rotatably coupled to respective platforms 285 by respective pivot axes 288. The platforms 285 can be cambered in relation to the platform 261 by drive motors 286, which can comprise servomotors. With this, a selective cambering of the platforms 285 will yield a steering of the caster wheels 282 and a resultant steering of the rear wheeled truck 264. The steering of the rear wheeled truck 262 can simulate losses in traction as described herein and, possibly, to maneuver and balance the vehicle 250.

As is shown in FIG. 19B relative to a forward portion of the vehicle 250, an alternative embodiment of the vehicle 250 can have a front wheeled truck 262 coupled directly to a steering member 258 with no caster being provided. The steering member 258 can be fixed against rotation in relation to the frame 252. All steering and lateral movements and accelerations of the forward portion of the vehicle can be exacted by a selective cambering of the platforms 272 in relation to the platform 259.

In certain practices of the invention, the vehicle 250 can be supplemented by a left and right wheeled foot trucks 290, such as that depicted in FIG. 20, on which the left and right feet of a user can be respectively disposed. The wheeled foot truck 290 in FIG. 20 has a foot pad 292 pivotally coupled to a base platform 299 at a pivot 302. First and second rear wheels 304 are rotatably retained relative to the base platform 299. The rear wheels 304 can be braked by braking motors 306 through braking couplings 308. First and second front caster wheels 294 are rotatably retained relative to respective casters 296, which are rotatably retained relative to the base platform 299. With this, the wheeled foot truck 290 can be readily moved laterally by a rider.

A sensor can be provided for detecting an amount of force applied to the respective foot truck 290 by a rider. While a number of such sensors would readily occur to one knowledgeable in the art after reading this disclosure, one presently contemplated sensor arrangement is shown in FIG. 20 in the form of a potentiometer 300 and spring 298 combination. With such a sensor arrangement provided, the sensed force applied by a rider could be exploited to further the riding experience. First, the sensed force can trigger a corresponding braking by the braking motors 206 and braking couplings 208 such that a rider would sense drag corresponding to what he or she would experience in applying force directly to a support surface. Again, varied coefficients of friction corresponding to various types of support surfaces could be simulated such that travel over ice, dirt, gravel, or any other support surface could be replicated. Second, the sensed force can be employed to affect the performance of the front and, more so, the rear wheeled trucks 262 and 264. For example, an increased force applied by the rider on a wheeled foot truck 290 disposed to a cambered side of the vehicle 250 will tend to decrease the traction simulated by the vehicle 250.

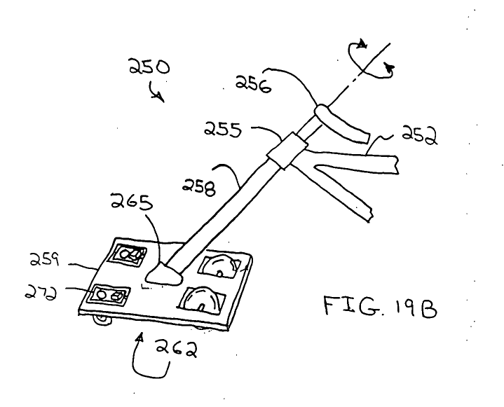

Caster steering could be employed in relation to a four-wheeled vehicle 350 as is shown in FIG. 22. The four-wheeled vehicle 350 can have traditional rear wheels 352. However, the front wheels of the vehicle 350 can each be replaced by a caster wheel 354 that is retained by a caster 356. Each caster 356 is rotatably retained relative to a camber platform 360 that is pivotally coupled to the frame 357 of the vehicle 350. With this, a pivoting of the camber platform 360 will induce a steering of the caster 356 and the caster wheel 354. When viewed in rear elevation, a counter-clockwise cambering of the camber platforms 360 will induce a steering of the vehicle 350 to the left while a clockwise cambering of the camber platforms 360 will steer the vehicle 350 to the right.

The vehicle 350 can in certain embodiments be remotely controlled. A remote control 351 can transmit control signals provided by a user by any effective means including a steering arrangement with acceleration and braking controls. In the remote control 351 of FIG. 22, left and right steering buttons 353A and 353B can steer the vehicle 350 by a selective pivoting of the camber platforms 360. Acceleration and braking buttons 353C and 353D can selectively accelerate or brake the vehicle 350. Under certain practices of the invention, the left and right steering buttons 353A and 353B can induce proportional steering of the casters 356 and caster wheels 354. For example, one contemplated embodiment of the invention can have a spring and potentiometer arrangement associated with each steering button 353A and 353B to provide a proportional steering signal to the vehicle 350. The camber of the camber platforms 360 can correspond in radians to the desired lateral acceleration expressed as a fraction of gravity.

During certain periods of control of the vehicle 350, there can be no braking or acceleration with a full right or left turn. There can also be periods of control with straight ahead steering with full acceleration or braking. At one-fourth scale, by way of example, there can be a one-quarter gravity left or right turn respectively or one-quarter gravity acceleration or braking respectively.

With a plurality of exemplary embodiments of the present invention disclosed, it will be appreciated by one skilled in the art that numerous changes and additions could be made thereto without deviating from the spirit or scope of the invention. This is particularly true when one bears in mind that the presently preferred embodiments merely exemplify the broader invention revealed herein. Accordingly, it will be clear that those with major features of the invention in mind could craft embodiments that incorporate those major features while not incorporating all of the features included in the preferred embodiments.

Therefore, the following claims shall define the scope of protection to be afforded the inventor. Those claims shall be deemed to include equivalent constructions insofar as they do not depart from the spirit and scope of the invention. It must be further noted that a plurality of the following claims may express certain elements as means for performing a specific function, at times without the recital of structure or material. As the law demands, these claims shall be construed to cover not only the corresponding structure and material expressly described in this specification but also equivalents thereof.

I claim as deserving the protection of Letters Patent:

1. A balance practice device for enabling a practice of two-wheeled vehicular balancing, the balance practice device comprising;
an inverted pendulum with an axis of rotation;
first and second lateral springs coupled in opposition to the inverted pendulum spaced from the axis of rotation thereof;
a steering arrangement wherein the steering arrangement is rotatably retained;
a means for providing proportional resistance against a rotation of the steering arrangement;
an actuating rod coupled to the steering arrangement wherein the actuating rod projects radially from the steering arrangement; and
an elongate flexible member with a first end coupled to the steering arrangement and a second end coupled to the first lateral spring;
whereby the inverted pendulum can be balanced by a selective steering of the steering arrangement.

2. The balance practice device of claim 1 further comprising a direction changing member interposed along the elongate flexible member and a means for adjusting an effective length of the elongate flexible member.

3. A system for remotely controlling two-wheeled vehicular motion over a support surface, the system comprising:
a first two-wheeled vehicle with a frame, a front wheel, a rear wheel, and a steering arrangement;
a second two-wheeled vehicle with a frame, a front wheel, a rear wheel, and a steering arrangement;
a pivotable linkage coupling arrangement for retaining the first and second two-wheeled vehicles in a substantially parallel relationship during a simultaneous banking of the first and second two-wheeled vehicles;
a means for receiving control signals from a user;
a means for enabling a transmission of the control signals to the two-wheeled vehicles; and
a control system for controlling the two-wheeled vehicles in response to control signals from the user;
whereby a user can manipulate the means for receiving control signals to attempt to steer, balance, and maintain overall stability of the two-wheeled vehicles during actual vehicular movement.

4. The system of claim 3 further comprising a sensor for detecting a bank angle of the first and second two-wheeled vehicles.

5. The system of claim 3 further comprising a motorized banking arrangement for inducing banking of the first and second two-wheeled vehicles and wherein the steering arrangements of the first and second two-wheeled vehicles are freely pivotable in response to banking of the first and second two-wheeled vehicles whereby a user can balance and maneuver the first and second two-wheeled vehicles by a selective banking of the two-wheeled vehicles.

6. The system of claim 5 wherein the bank angle to which the motorized banking arrangement tilts the first and second two-wheeled vehicles corresponds in radians to a lateral acceleration predicted under the Theoretical Method of Operation expressed as a fraction of gravity.

7. The system of claim 3 further comprising a laterally moveable weight associated with at least one of the two-wheeled vehicles whereby an effective center of gravity of the at least one two-wheeled vehicle can be adjusted to enable a balancing and maneuvering of the first and second two-wheeled vehicles.

8. The system of claim 7 wherein the means for receiving control signals from a user comprises a means for sensing a user's change in center of gravity.

9. The system of claim 3 further comprising a means for inducing a steering of the steering arrangements of the first and second two-wheeled vehicles whereby balance and banking of the first and second two-wheeled vehicles can be controlled merely by steering the first and second steering arrangements.

10. A system for simulating two-wheeled vehicular motion over a support surface, the system comprising:
a platform;
an occupant controlled two-wheeled vehicle retained in relation to the platform wherein the two-wheeled vehicle comprises a frame, a front wheel, and a rear wheel;
a means for moving the frame laterally;
a display means for displaying a scene relative to a user wherein the display means for displaying a scene includes a means for tilting the scene to a bank angle;
a means for receiving control signals from a user;
a control system for moving the two-wheeled vehicle laterally in relation to the platform in response to control signals from the user and a means for inducing a banking of the scene displayed by the display means;
whereby a user can manipulate the means for receiving control signals to induce a lateral movement of the two-wheeled vehicle and a banking of the scene.

11. The system of claim 10 wherein the display means comprises a display means chosen from the group consisting of a display screen and virtual reality eyewear.

12. The system of claim 10 wherein a lateral acceleration of the frame expressed as a fraction of gravity is calibrated to correspond to the bank angle expressed in radians.

13. A system for simulating two-wheeled vehicular motion over a support surface, the system comprising:
a pivotally supported support arm;
an occupant controlled two-wheeled vehicle retained in relation to the support arm wherein the two-wheeled vehicle comprises a frame, a front contact portion, and a rear contact portion;
a means for pivoting the support arm to enable a raising and lowering of the two-wheeled vehicle;
a means for receiving control signals from a user;
a control system for moving the support arm in response to control signals from the user.

14. The system of claim 13 further comprising a display means for displaying a scene relative to a user.

15. The system of claim 13 wherein the front and rear contact portions each essentially comprise a single location and further comprising a three-dimensional motion simulation arrangement operably associated with each of the first and second contact portions for inducing three-dimensional movement.

16. A wheeled vehicle comprising:
a vehicle frame with a longitudinal orientation;
a front wheeled truck coupled to the vehicle frame wherein the front wheeled truck has an angle of attack, wherein the front wheeled truck has a caster wheel retained relative to a caster, and wherein the caster is rotatably coupled to the front wheeled truck with an axis of rotation and further comprising a means for banking the caster to a camber angle thereby to induce a turning of the caster and a steering of the caster wheel wherein the front wheeled truck is pivotable in relation to the vehicle frame whereby a steering of the caster wheel can induce a difference between the angle of attack of the front wheeled truck and the longitudinal orientation of the vehicle frame;
a rear wheeled truck coupled to the vehicle frame wherein the rear wheeled truck has an angle of attack, wherein the rear wheeled truck has a caster wheel retained relative to a caster, and wherein the caster is rotatably coupled to the rear wheeled truck with an axis of rotation and further comprising a means for banking the caster to a camber angle thereby to induce a turning of the caster and a steering of the caster wheel wherein the rear wheeled truck is pivotable in relation to the vehicle frame whereby a steering of the caster wheel can induce a difference between the angle of attack of the rear wheeled truck and the longitudinal orientation of the vehicle frame; and
a steering arrangement operably associated with the vehicle frame and at least one of the front or rear wheeled trucks.

17. The wheeled vehicle of claim 16 wherein the front wheeled truck has a front platform and a rear platform, wherein the caster is rotatably coupled to the front platform, and wherein the means for banking the caster comprises a means for cambering the front platform and further comprising a rear wheel rotatably coupled to the rear platform.

18. The wheeled vehicle of claim 16 wherein the rear wheeled truck has a front platform and a rear platform, wherein the caster is rotatably coupled to the front platform, and wherein the means for banking the caster comprises a means for cambering the front platform and further comprising a rear wheel rotatably coupled to the rear platform.

19. The wheeled vehicle of claim 16 wherein there are first and second front wheeled trucks and first and second rear wheeled trucks.

20. The wheeled vehicle of claim 16 further comprising a motor for propelling the rear wheeled truck.

21. The wheeled vehicle of claim 16 further comprising a means for simulating a loss in traction of at least one of the front wheeled truck and the rear wheeled truck wherein the means for simulating a loss in traction comprises the means for banking the caster to steer away from the longitudinal orientation of the vehicle frame to achieve a skidding orientation where the angle of attack of the wheeled truck or trucks departs from the longitudinal orientation of the vehicle frame.

22. The wheeled vehicle of claim 21 further comprising at least one sensor for detecting the angle of attack of the wheeled truck or trucks.

23. The wheeled vehicle of claim 22 further comprising a means for torquing the steering arrangement in proportion to the difference between the angle of attack of the wheeled truck or trucks and the longitudinal orientation of the vehicle frame.

24. The wheeled vehicle of claim 22 wherein the camber angle of the caster is calculated as follows:
Ψ=[(A_{K} sin θ)+√(0.09−A_{K} cos θ)]
Where,
θ is the angle of attack of the wheeled truck;
Ψ is the angle to which the caster is cambered when viewed in rear elevation; and
A_{K} is the longitudinal acceleration of the vehicle.

25. The wheeled vehicle of claim 22 wherein the acceleration of the wheeled truck is calculated as follows:
A_{T}=[A_{K} cos θ+√(0.09−A_{K} sin θ)]
Where,
θ is the angle of attack of the wheeled truck;
A_{K} is the longitudinal acceleration of the vehicle; and
A_{T} is the acceleration, which can be positive or negative, of the wheeled truck.

26. The wheeled vehicle of claim 22 wherein the camber angle of the caster is calculated as follows:
For Φ<−0.03 or Φ>0.03
Ψ=0.3 cos Φ
For Φ>=−0.03 or Φ<=0.03
Ψ=10 Ψ
Where,
Φ is the difference between the angle to which the steering arrangement is turned and the angle of attack of the wheeled truck;
Ψ is the angle to which the caster is cambered when viewed in rear elevation.

27. The wheeled vehicle of claim 22 wherein the acceleration of the wheeled truck is calculated as follows:
For Φ<−0.03 or Φ>0.03
A_{T}=0.3 sin Φ
For Φ>=−0.03 or Φ<=0.03
A_{T}=0
Where Φ is the difference between the angle to which the steering arrangement is turned and the angle of attack of the wheeled truck;
A_{T} is the acceleration, which can be positive or negative, of the wheeled truck.
